(19) United States
(12) Patent Application Publication
(10) Pub. No.: US 2005/0161866 A1
(43) Pub. Date: Jul. 28, 2005

(54) Process of making two-stage injection stretch blow molded polypropylene articles

(76) Inventors: Rajnish Batlaw, Spartanburg, SC (US); Brian M. Burkhart, Greenville, SC (US); Bernard Vermeersch, Gent (BE); Pedro Van Hoecke, Sparatanburg, SC (US); Marc Delaere, LoChristi (BE); Roberto Guzman Pedroza, Mexico (MX); Jenci Kurja, Knokke-Heist (BE)

Correspondence Address: John E. Vick, Jr.;Legal Department, M-495, PO Box 1926, Spartanburg, SC, 29304, US

(21) Appl. No.: 10/764,234

(22) Filed: Jan. 23, 2004

(51) Int. Cl. B29C 49/00

(52) U.S. Cl. 264/537

(57) ABSTRACT

The two stage production of clear, low-haze, injection stretch blow molded polypropylene container articles is disclosed. In the first processing stage, a preform article is manufactured on an injection molding machine. In a second and subsequent step, which may occur remotely from apparatus used in the first step, the preform article is heated and stretch blown into a container. The process may employ the selection of processing parameters to produce preform articles that facilitate stretch blow molding at relatively high rates of speed, while still maintaining an appropriate polypropylene polymer morphology that results in clear, low haze containers.

### FIELD OF THE INVENTION

This invention relates to production of two-stage injection stretch blow molded polypropylene articles.

### BACKGROUND OF THE INVENTION

Injection stretch blow molding is a process of producing thermoplastic articles, such as liquid containers. This process involves the initial production of a preform article by injection molding. Then, the preform article that after reheating is subjected to stretching and gas pressure to expand (blow) the preform article against a mold surface to form a container.

There are several different processes that employ stretch blow molding. A first type is a single stage process in which a preform is made on a machine and allowed to cool somewhat to a predetermined blow molding temperature. While still at this elevated temperature, the preform is stretch blow molded into a container on the same machine, as part of a single manufacturing procedure. This is a one step or so-called “single stage” manufacturing procedure. In a typical single stage blow molding process for polypropylene, the temperature of the preform is cooled (reduced) following preform formation from about 230° C. to about 120-140° C. The preform is not returned to ambient temperature, but instead is blown to a container while at about 120 to 140° C.

Another type of process is a two stage process. In a two stage process, preforms first are formed in an injection machine. Then, preforms are cooled to ambient temperature. In some cases, preforms are shipped from one location to another (or from one company to another) prior to stretch blowing the preforms into containers. In the second stage of the two-stage process, preforms are heated from an initial ambient temperature to an elevated temperature for stretch blowing on a molding machine to form a container. The injection machine and the molding machine typically are located apart from one another in such a two stage procedure. Two stage manufacturing processes are sometimes referred to as “reheat stretch blow molding” (RSBM) processes, because preform articles formed in the first stage are subsequently reheated during the second stage of manufacture to form finished containers.

Two stage container manufacture is comprised of: (1) injection and cooling of a preform to ambient temperature, followed by (2) stretch blow molding to form a container. Two stage manufacturing reveals certain advantages over single stage processes. For example, preform articles are smaller and more compact than containers. Therefore, it is easier and less costly to transport large numbers of preform articles, as compared to transporting large numbers of containers. This fact encourages producers to make preform articles in one location, and manufacture containers in a second location, reducing overall production costs. Thus, one advantage of two stage container manufacture is that it facilitates separate optimization of each stage of manufacturing. Furthermore, it is recognized that the two stage process is more productive and provides more opportunities for cost savings for large volume applications.

It is common, therefore, for a two-stage process to be used in applications for which large volumes of containers are to be made. Thus, a preform may be shipped to a location at which the finished containers will be employed in the marketplace. Then, in that instance, actual shipping costs for completed containers will be greatly reduced. The explanation for this is that the shipping costs for fully blown containers are significantly greater than shipping costs for preforms, which are much smaller and more compact. Thus, two-stage processes are used commonly for large volume product applications such as drink bottles, soda bottles, water bottles and the like. On the other hand, it is common in the industry for one stage processes to be used for bottles which are used commercially in much smaller volumes.

St retch blown thermoplastic articles formed of polyethylene terephthalate (PET) are common in the industry. Such polyesters provide highly transparent and aesthetically pleasing container articles. PET bottle production has enjoyed tremendous success in the last twenty years. However, there is a continuing drive in the industry to reduce costs while still providing containers of suitable quality and clarity. Overall production cost for containers is a function of many factors, including raw material cost and also manufacturing speed or efficiency.

In the industry, it is known to make containers from polypropylene. Polypropylene in general is a lower cost raw material as compared to PET. However, polypropylene has not significantly replaced PET as the material of choice for drink bottle manufacturing. One reason that polypropylene has not replaced PET as the material of choice, given its lower overall raw material costs, is that the injection and blow molding cycle time for polypropylene has been excessively long. The long cycle time for preform and bottle production drives up the cost for using polypropylene as compared to PET for container manufacture.

Productivity for polypropylene preform production in conventional processes is low in part because of the undesirably high preform thickness and the use of thermal gates. This is a surprising and unexpected discovery of the invention, that is, a process of achieving suitable container structure and morphology by reducing preform thickness.

In the past, conventional processes have employed a rapid injection rate. It has been mainly the long cooling time that has caused the cycle time for polypropylene preforms to be cost prohibitive. Using a relatively fast injection rate (could still be a short cycle-time) for thin walled preforms unexpectedly can lead to bottles having low clarity. High injection rates in conventional prior art preform manufacture sometimes have adversely affected the orientation of the crystal structure in the preform, which induces undesirable haze in the final container. To produce containers with sufficient clarity, it has been common to use relatively long cycle times (for preforms and containers) when employing polypropylene.

There has been a long felt need in the industry for a process of making polypropylene containers on existing PET manufacturing equipment that is already deployed in the industry. Currently known methods of injection stretch blow molding PET preforms have generally not been successfully employed for polypropylene container manufacture.

The shape and thickness of preforms will determine their suitability for container manufacture and the speed at which containers may be stretch molded from such preforms. It has been common in conventional polypropylene processes to employ polypropylene preforms having fairly thick walls. However, thick preform walls reduce the processing speeds that can be achieved. Thick-walled preforms must be cooled longer before removal from a preform mold, thus undesirably increasing processing time in preform manufacture.

U.S. Pat. No. 4,357,288 to Oas et al. discloses a method of manufacture of biaxially oriented polyolefin bottles. The injection rate for production of preforms, however, is relatively slow. This patent describes an injection rate of polypropylene to fill a mold cavity which uses an injection time of about 3 to 10 seconds to fill the mold cavity. Examples of the Oas patent disclosure recite a machine cycle of about 7 seconds, which corresponds to a container production of about 500 containers per hour.

Several prior art references are directed to single stage bottle manufacturing processes, or extrusion-type processes. For example, European patent application 0 151 741 A2 to Ueki et. al. (Mitsui Toatsu Chemicals) is directed to single stage manufacturing of containers or bottles. EP 0 309 138 A2 (Exxon) teaches the use of polypropylene to form containers. This Exxon patent disclosure is directed to one stage preform/container manufacturing processes.

An additional publication, WO03/0353368 to Richards et. al (Pechiney Emballage Flexible Europe) is directed to the two stage production of multilayer containers from polypropylene. An additional barrier layer of EVOH is provided in addition to the polypropylene layer. However, this patent disclosure teaches the use of a melt flow index that is relatively low, resulting in a relatively viscous polypropylene resin. Viscous resins are not easily adapted to rapid injection rates in the manufacture of preforms. This reduces overall productivity and manufacturing efficiency.

Yet another publication, WO 95/11791 to Gittner et al, (Bekum Maschinenfabriken GMBH) is directed to a two stage process for container manufacture using polypropylene. This process employs an injection cavity fill rate during manufacture of the preform of about 3-5 grams per second. It is believed that the process cannot reliably form polypropylene containers at a container production rate of more than about 900 containers per cavity per hour.

Until the development of this invention, many attempts to injection stretch blow mold polypropylene have been commercially undesirable. This has been believed to be due in part to a relatively slow production speed for such polypropylene articles at acceptable container haze levels. In addition, it was generally believed that special stretch blow molding machines equipped with longer re-heating ovens were required to reliably produce polypropylene containers.

A disadvantage of polypropylene containers has been the inability to make containers of high clarity (i.e. low haze) at a high rate of speed. For example, it has been known to make relatively clear polypropylene containers having a percentage haze value of about 1-1.5 percent haze. However, conventional methods for making polypropylene containers having such low levels of haze have been relatively slow. Slow processes are not economically viable in the marketplace. It is a significant and difficult challenge to develop a process that will facilitate increased stretch molding speed while not sacrificing clarity of the resulting container.

There has been a long felt need in the industry of container manufacturing to provide polypropylene materials, preforms, and container articles in a process that will afford a cost-effective manufacture of low-haze, high clarity products. A process of employing polypropylene in a manner that will result in highly efficient preform and container production at a minumum cost with a fast cycle time is very desirable.

### BRIEF DESCRIPTION OF THE DRAWINGS

The invention will now be described by way of example with reference to the drawings:

FIG. 1 shows a typical polypropylene container that may be manufactured according to the process of the invention;

FIG. 2A is a schematic flow diagram showing the processing steps employed in the first stage of the two stage process, which relates to injection manufacture of preform articles;

FIG. 2B illustrates processing steps in the second stage of manufacturing in accord with the invention, wherein a preform article is stretch blow molded to form a container;

FIG. 3 is a side view of a conventional thick-walled preform article;

FIG. 3A shows a side cross-sectional view of the conventional preform article of FIG. 3;

FIGS. 3B and 3C show a first embodiment of a relatively thin walled preform with an external profile that may be employed in the invention;

FIG. 4 shows a side view of a second preform that may be used in the invention, i.e. a relatively thin-walled preform article according to the practice of the invention, in which the preform article optionally may have a profile on the inside rather than the outside of the preform article structure;

FIG. 4A shows a cross-sectional view of the thin-walled preform article of FIG. 4;

FIG. 5 is a longitudinal sectional view of an injection molding assembly for the production of a preform article;

FIG. 6 is an illustration of stage two of the manufacturing process, showing a vertical cross-sectional view of stretch blow mold apparatus that is used to produce the containers from a perform, in this view showing a start up position with the preform article in place;

FIG. 7 is a view of the apparatus of FIG. 6 showing the mold closed on the preform article; and

FIG. 8 shows a fully blown container with a stretch rod and swage in a down position with the container decompressing in the mold.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

A two-stage process of injection stretch blow molding polypropylene to form a container is disclosed in the practice of the invention. A first stage of this process comprises forming a preform article. A second subsequent stage comprises reheating and blow molding the preform article to form a container. The invention is directed to both preform articles and containers, in addition to the specific method or process for forming these products. Surprisingly beneficial results have been achieved in the practice of the invention.

In the first stage of forming a preform article, a process is provided having at least the following steps. First, a chemical composition comprising at least in part polypropylene is provided. This chemical composition provides a melt flow index in the range of between about 6 and about 50 grams/10 minutes, according to ASTM D 1238 at 230 degrees C./2.16 kg.

Further, the chemical composition is injected into a mold at a fill rate of greater than about 5 grams of chemical composition per second. This injection may be made through an orifice or gate, as further described herein. A preform article is formed in a mold. The preform article is removed from the mold. The preform article includes a closed end adapted for subsequent second stage reheating and stretch blow molding. The closed end may be integral with a side wall. The side wall of the preform provides a thickness of less than about 3.5 mm, in one aspect of the invention.

Processing parameters are employed in the practice of the invention to produce preform articles that facilitate fast and efficient stretch blow molding to produce containers having a desirably low haze. The melt flow index (MFI) of the polypropylene chemical compositions (i.e. resins) will be tuned to the injection speed of resin in molding the preform article, the thickness and structure of the preform article, and the proper selection of injection gate diameter during such the preform production stage. Each of these factors are important to the successful production of desirable low-haze container articles. Improved containers, preforms, and processing conditions are within the scope of this invention.

The invention has overcome limitations in the art, in part by the unexpected discovery that processing parameters may be established to impart necessary conditions and benefits to form superior polypropylene-based preforms. This invention facilitates efficient and cost-effective production of clear, low haze polypropylene articles from preforms using injection to make a preform, followed in some instances by stretch blow molding to form a container.

It is highly desirable to improve the speed of production and reduce the level of haze in the thickest regions of the resultant container articles as well. Nucleating agents may be employed in the practice of the invention, but are not always necessary. For injection stretch blow-molded bottles, as one example, the neck and the bottom are generally the most difficult areas to clarify due to the thickness of such regions. In particular, the aesthetic qualities of neck areas can be compromised if the appearance is too hazy or cloudy.

The advantages of the process disclosed herein comprise, among other things, appropriate selection of melt flow polypropylene resins, appropriate selection of nucleating and clarifying agents, appropriate thickness of performs, appropriate rate or speed of injecting the resin for preform production, and also perhaps the appropriate gate width during preform production. Surprisingly, it has been found that there are ranges for each of these criteria which cause stretch blow molded articles to be produced at high rates with superior clarity.

Polypropylene has long been known to exist in several forms, and essentially any known form could be used in the practice of the invention. Thus, the invention is not limited to any particular type of polypropylene. Isotactic propylene (iPP) may be described as having the methyl groups attached to the tertiary carbon atoms of successive monomeric units on the same side of a hypothetical plane through the polymer chain, whereas syndiotactic polypropylene (sPP) generally may be described as having the methyl groups attached on alternating sides of the polymer chain.

Additionally, container articles produced in accordance with the criteria noted above exhibit specific haze to thickness ratios, and such is within the scope of the present invention. The invention provides a vast improvement in polypropylene injection stretch blow-molded article technology whereby efficient methods of producing very clear articles is accorded as proper replacements for previous PET types.

The practice of the invention makes it possible to provide injection stretch blow-molded polypropylene articles that may be produced at very high rates and exhibit substantially uniform clarity levels. The invention may provide polypropylene preforms that facilitate production of very low haze container articles with injection stretch blow molding in a very efficient manner. One application of the invention provides improved containers, wherein such containers (or bottles) exhibit low haze levels.

### Optional Nucleating Agents

An effective clarifying agent, that also functions as a nucleator, for polypropylene is 1,3-O-2,4-bis(3,4-dimethylbenzylidene) sorbitol (hereinafter DMDBS), available from Milliken & Company under the trade name Millad® 3988. Such a compound provides highly effective haze reductions within polypropylenes with concomitant low taste and odor problems. Disubstituted DBS compounds are broadly described in U.S. Pat. Nos. 5,049,605 and 5,135,975 to Rekers. As it is, in terms of providing excellent clarity, particularly within the neck and bottom regions of target injection stretch blow-molded polypropylene bottle articles within this invention, DMDBS is a useful compound for such a result.

An effective thermoplastic nucleator in terms of high crystallization temperatures is available from Milliken & Company using the tradename HPN-68™. Other like thermoplastic nucleating compounds that may be employed in the practice of the invention are disclosed in U.S. Pat. Nos. 6,465,551 and 6,534,574. The HPN-68™ compound is disodium bicyclo[2.2.1]heptanedicarboxylate. The ability to provide highly effective crystallization, or, in this specific situation, control targeted levels of crystallization within polypropylene preforms prior to injection stretch blow molding sometimes is facilitated by utilization of such a nucleating agent. Low amounts of this additive can be provided to produce the desired and intended amorphous-crystalline combination within the target performs.

Other nucleating agents can be employed in the practice of the invention. These include dibenzylidene sorbitol compounds (such as unsubstituted dibenzylidene sorbitol, or DBS, and p-methyldibenzylidene sorbitol, or MDBS), sodium benzoate, talc, and metal salts of cyclic phosphoric esters such as sodium 2,2′-methylene-bis-(4,6-di-tert-butylphenyl)phosphate (from Asahi Denka Kogyo K.K., known as NA-11), and cyclic bis-phenol phosphates (such as NA-21®, also available from Asahi Denka), metal salts (such as calcium) of hexahydrophthalic acid, and, as taught within Patent Cooperation Treaty Application WO 98/29494, to 3M, the unsaturated compound of disodium bicyclo[2.2.1]heptene dicarboxylate. Such compounds all impart relatively high polypropylene crystallization temperatures. Commercially available products suitable for use in the practice of the present invention include not only Millad® 3988 (3,4-dimethyldibenzylidene sorbitol) mentioned above, but also NA-11® (sodium 2,2-methylene-bis-(4,6, di-tert-butylphenyl)phosphate, available from Asahi Denka Kogyo, and aluminum bis[2,2′-methylene-bis-(4,6-di-tert-butylphenyl)phosphate], known commercially as NA-21®, also available from Asahi.

The following nucleating agents could be used in the practice of the invention: sodium 1,3-O-2,4-bis(4-methylbenzylidene) sorbitol and derivatives thereof: 1,2-cyclohexanedicarboxylate salts and derivatives thereof; aluminum 4-tert-butylbenzonate and derivatives thereof; and metal salts of cyclic phosphoric esters and derivatives thereof.

Nucleating agents, clarifying agents, HHPA and/or bicyclic salts, as further described herein, may be added to polypropylene in an amount from about 0.01 percent to about 10 percent by weight. In most applications, however, less than about 5.0 percent by weight of such nucleating agents are needed. In other applications, such compounds may be added in amounts from about 0.02 to about 3.0 percent. Some applications will benefit from a concentration of about 0.05 to 2.5 percent, to provide beneficial characteristics (1.0% by weight equals about 10,000 ppm).

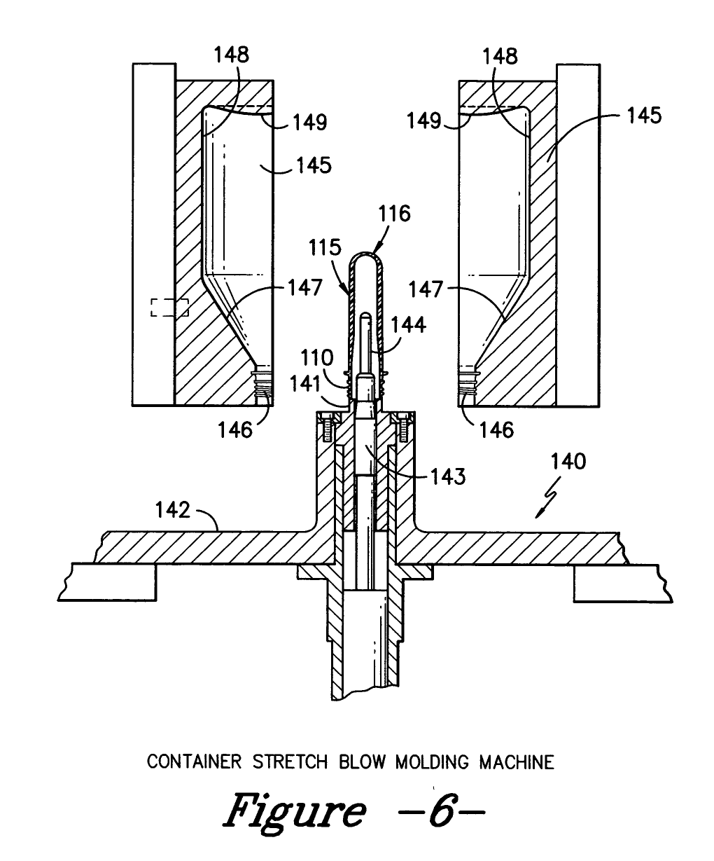

It may be desirable to include up to 50% or more of an active nucleating agent compound in a masterbatch, prior to full homogenous mixing, although this is not a restriction or a requirement. Optional additives in addition to the nucleating salt-containing composition may include plasticizers, stabilizers, ultraviolet absorbers, and other similar thermoplastic additives. Other additives also may also be present within this composition, most notably antioxidants, antimicrobial agents (such as silver-based compounds, preferably ion-exchange compounds such as ALPHASAN® brand antimicrobials from Milliken & Company), antistatic compounds, perfumes, chloride scavengers, and the like. Co-additives, along with the nucleating agents, may be present as an admixture in powder, liquid, or in compressed or pelletized form for easy feeding as shown in FIG. 5 herein. The use of dispersing aids may be desirable, such as polyolefin (e.g., polyethylene) waxes, stearate esters of glycerin, montan waxes, and mineral oil.

### Polypropylene Compositions

The polypropylene polymers employed in the practice of the invention may include homopolymers (known as HPs), impact or block copolymers (known as ICPs)(combinations of propylene with certain elastomeric additives, such as rubber, and the like), and random copolymers (known as RCPs) made from at least one propylene and one or more ethylenically unsaturated comonomers. Generally, co-monomers, if present, constitute a relatively minor amount, i.e., about 10 percent or less, or about 5 percent or less, of the entire polypropylene, based upon the total weight of the polymer. Such co-monomers may serve to assist in clarity improvement of the polypropylene, or they may function to improve other properties of the polymer. Co-monomer examples include acrylic acid and vinyl acetate, polyethylene, polybutylene, and other like compounds.

Polypropylene provides an average molecular weight of from about 10,000 to about 2,000,000, preferably from about 30,000 to about 300,000, and it may be mixed with additives such as polyethylene, linear low density polyethylene, crystalline ethylenepropylene copolymer, poly(1-butene), 1-hexene, 1-octene, vinyl cyclohexane, and polymethylpentene, as examples. Other polymers that may be added to the base polypropylene for physical, aesthetic, or other reasons, include polyethylene terephthalate, polybutylene terephthalate, and polyamides, among others.

Resin compositions utilized to produce the preform articles and injection stretch blow-molded containers of the invention can be obtained by adding a specific amount of a nucleating agent/clarifying agent directly to the polypropylene, either in dry form or in molten form, and mixing them by any suitable means while in molten form to provide a substantially homogenous formulation. Alternatively, a concentrate containing as much as about 20 percent by weight of a nucleator/clarifier in a polypropylene masterbatch may be prepared and be subsequently mixed with the resin. Furthermore, the desired nucleator/clarifier (and other additives, if desired) may be present in any type of standard polypropylene additive form, including, without limitation, powder, prill, agglomerate, liquid suspension, and the like, particularly comprising dispersion aids such as polyolefin (e.g., polyethylene) waxes, stearate esters of glycerin, waxes, mineral oil, and the like. Essentially any form may be exhibited by such a combination or composition including such combination made from blending, agglomeration, compaction, and/or extrusion. The produced resins are then utilized to form preforms, as noted herein, which are then subsequently utilized to form the desired container articles in an injection stretch blow molding procedure.

Other additives may also be used in the composition of the present invention. It may even be advantageous to premix such additives or similar structures with the nucleating agent to reduce its melting point and thereby enhance dispersion and distribution during melt processing. Such additives are known to those skilled in the art, and include plasticizers (e.g., dioctyl phthalate, dibutyl phthalate, dioctyl sebacate, mineral oil, or dioctyl adipate), transparent coloring agents, lubricants, catalyst neutralizers, antioxidants, light stabilizers, pigments, other nucleating agents, and the like. Some of these additives may provide further beneficial property enhancements, including improved aesthetics, easier processing, and improved stability to processing or end use conditions.

In particular, it is contemplated that certain organoleptic improvement additives be added for the purpose of reducing the migration of degraded benzaldehydes from reaching the surface of the desired article. The term “organoleptic improvement additive” is intended to encompass such compounds and formulations as antioxidants (to prevent degradation of both the polyolefin and possibly the target alditol derivatives present within such polyolefin), acid neutralizers (to prevent the ability of appreciable amounts of residual acids from attacking the alditol derivatives), and benzaldehyde scavengers (such as hydrazides, hydrazines, and the like, to prevent the migration of foul tasting and smelling benzaldehydes to the target polyolefin surface).

High rate production of preforms contributes significantly to the improved efficiency in producing of injection stretch blow-molded articles, in terms of high clarity, acceptable physical properties, and high manufacturing efficiency.

Polypropylene compositions having an melt flow index (MFI) of between about 6 and about 60 are useful in the practice of the invention. Furthermore, MFI values of between about 13 and about 35 are particularly useful in the practice of the invention, as further described below.

An injection speed of the chemical composition (i.e. polypropylene and various additives) into a preform cavity mold at a fill rate of greater than about 5 grams of chemical composition per second has been found to be particularly valuable in the practice of the invention. Table A shows values for various parameters that may be employed in the practice of the invention, as further discussed herein.

In addition to the injection speed of the specific MFI resin, the thickness and design of the target preform is important for a number of reasons. The thickness of such an article should be thin, as compared with the thickness of previously produced polypropylene preforms. This facilitates low haze results as noted above, and also facilitates utilization within prior PET injection stretch blow molding machinery. The side wall thickness of preforms desirably may be less than about 3.5 mm for effective results. In some applications, side wall thickness of between about 1.5 mm and 3.5 is very useful. Some applications may use a thickness of as much as 4.0 mm, as set forth in Table A.

A gate, as further described herein, comprises the opening through which liquid chemical composition (polypropylene and additive mixture) is admitted into the preform mold cavity. The gate diameter employed during preform production is particularly important, and may be related to other processing variables. A wider gate during injection into the mold cavity, coupled with the particular speed or speed range at which the resin is injected, facilitates greater control and influence upon the degree of polymer crystal orientation resulting therefrom. In the practice of the invention, a gate diameter of 1.5 mm may be used. In other applications, a gate diameter of 3.8 mm has been used. Other gate sizes could be used as well, but each factor or factor must be adjusted to account for gate diameter. Gate diameters between about 1.5 mm and 3.8 mm can be advantageously employed in the practice of the invention.

### Further Detailed Description of the Drawings

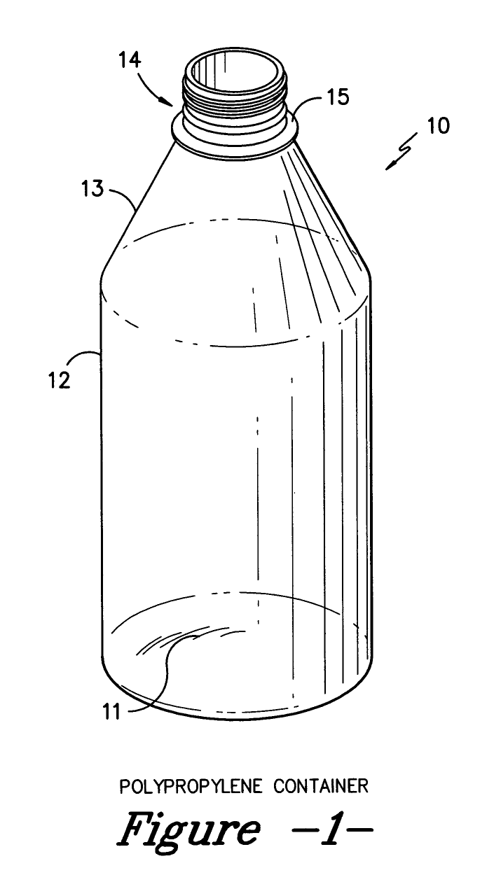

FIG. 1 shows a stretch blow molded polypropylene container that may be manufactured in accordance with the practice of the invention. Container 10 (sometimes referred to herein as a “bottle”) is shown. The container 10 of FIG. 1 has a relatively concave bottom 11, a cylindrical main sidewall 12, a conical upper portion 13, and a thickened externally threaded neck 14 on the convergent end of the upper portion 13. A neck ring 15 provides a physical point of reference, and may be used to carry the container 10 along processing machinery during manufacture and subsequent filling of the container 10.

The container 10 may be of any desired size or shape with sizes of from 0.5 to 4 liters being very useful, for example. The neck 14 usually is rigid to support a pressure retaining screw type cap (not shown). Thus, the neck 14 may be many times the thickness of the sidewall 12. Furthermore, the conical upper portion 13 may be gradually thickened as it approaches neck 14.

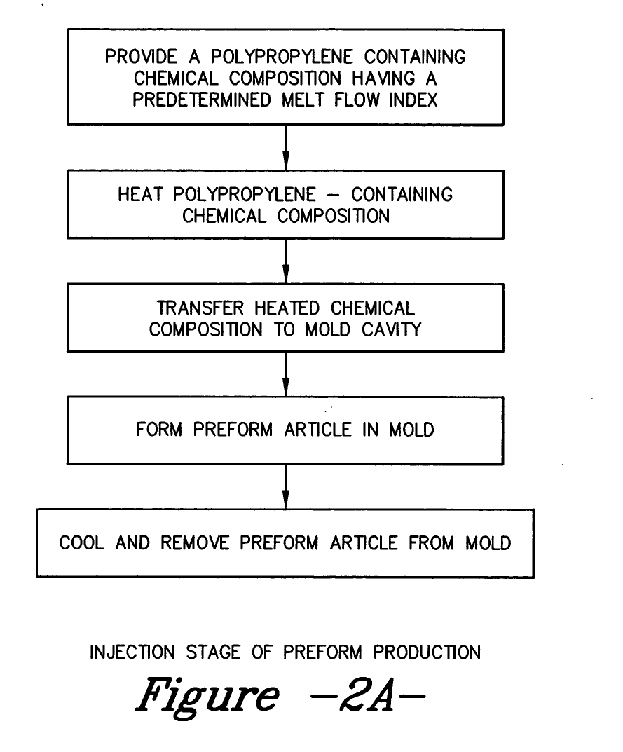

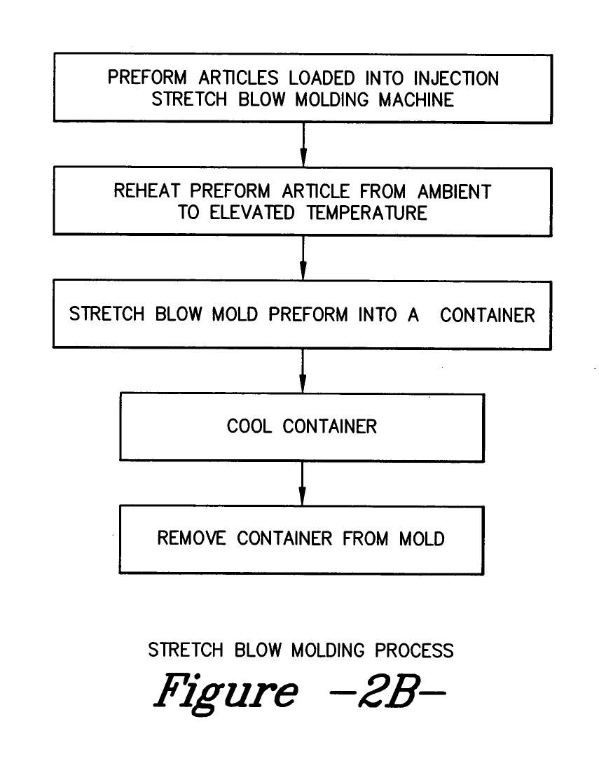

Turning now to FIG. 2A, a flow schematic is provided showing the steps in the first stage of a two-stage stretch blow molding process. In the invention, a two stage (two step) procedure is provided for production of containers 10. FIG. 2A shows the first stage of the manufacturing procedure, that is, the injection molding process of preforms production. A chemical composition containing polypropylene is acquired from a source, such as a polypropylene manufacturer. The polypropylene-containing chemical composition may comprise a homopolymer, copolymer or other polymeric composition. Furthermore, the chemical composition (also known as a “resin”) may contain various additives, including (for example) nucleating agents, antioxidants, lubricants, s-scavengers, UV absorbers and the like, as further described herein. The polypropylene chemical composition is provided into an injection machine and heated. The heated chemical composition then is injected at a relatively high rate of speed through a valve or “gate”, and into the mold of the injection machine. A preform article is formed in a mold. The preform article is cooled and removed from the mold.

FIG. 2B shows a second stage of a two-stage stretch blow molding process. In the second stage, a preform article (which may or may not have been manufactured at a location distant from the stretch blow molding apparatus) is converted to a container 10. A preform article (usually at ambient temperature) is provided in a stretch blow molding machine. Then, the preform article is heated from ambient temperature to an elevated temperature. The elevated temperature employed is also known as the “orientation” temperature, and it is typically in the range of about 120-130° C. for random copolymers.

The inner surface temperature of the preform needs to be sufficiently high to ensure that containers have the best optical properties. This has been found to be one important variable in the stretch blow molding process which sometimes determines whether the container will be transparent or hazy. When the preform article is sufficiently softened, the preform is stretch blow molded into a container 10. The formed container 10 is cooled and removed from the stretch mold apparatus.

### Conventional Thick-Walled Preform

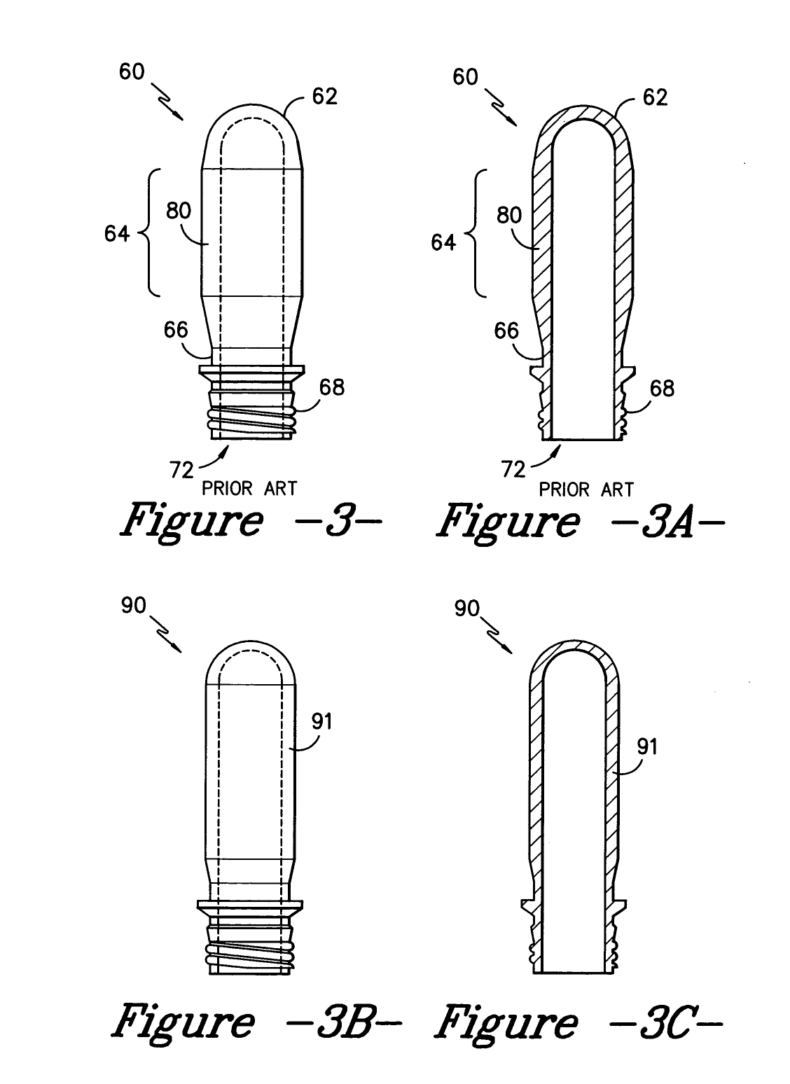

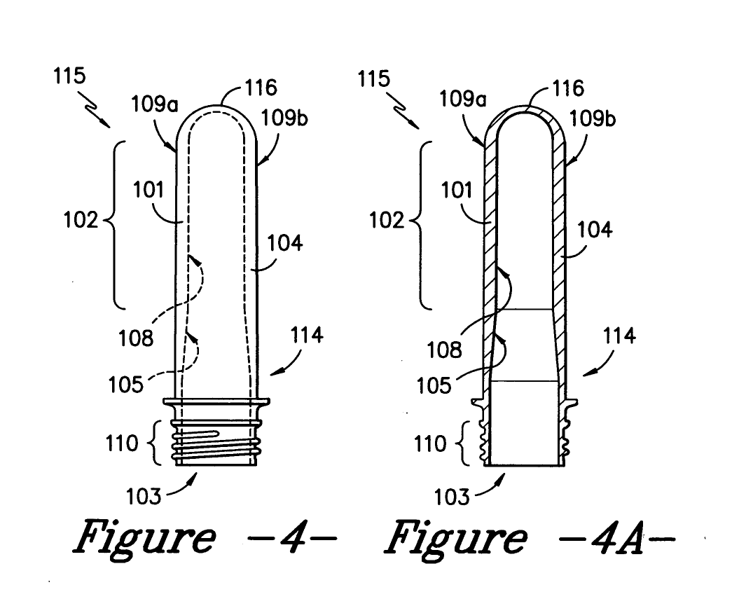

FIGS. 3-3A show a thick-walled polypropylene preform having a relatively thick side wall 80 (in this example, the side wall thickness is about 5 mm). The preform article 60 shown in FIG. 3 includes a dosed end 62 and an open end 72. Furthermore, a neck 66 is shown, with threads 68 at the base of the neck 66. A main body portion 64 with side wall 80 is shown. It is common for polypropylene-based preforms 60 such as that shown in FIG. 3 to have a side wall 80 having a thickness of about 5 mm, or more.

This preform article 60 happens to also be “stepped out” or tapered at each end, on its exterior profile. Thus, a “profile” is found on the exterior of many preform articles. In many cases, the size of the threads at the open end 72 are fixed, and cannot be subject to variation.

### First Type of Preform Article that may be Employed in the Practice of the Invention

FIG. 3B and corresponding FIG. 3C show a first embodiment of a thin walled preform article that may be employed in the practice of the invention. It should be noted that the invention may include the use of “stepped out” preforms with an exterior profile, such as shown in FIGS. 3B/3C so long as the preforms are less than about 3.5 mm in side wall width.

Thus, one discovery of the invention is that thin-walled preforms, in conjunction with processing conditions presented herein, provide surprisingly unexpected results as compared to conventional thick walled preforms. In the FIGS. 3B/3C a preform 90 having thin side wall 91 is shown.

### Second Type of Preform Article Employed in the Invention

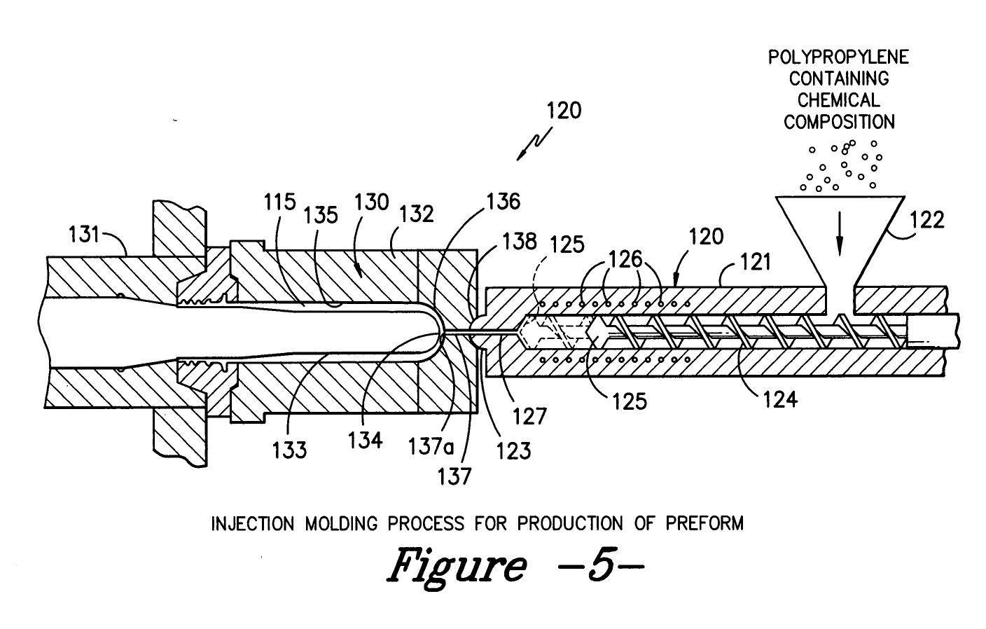

The geometry of a preform article is important in the manufacturing of containers 10. In the practice of the invention, a preform article 115 having a relatively thin side wall may be employed, as further described herein and as shown in FIGS. 4-4A. The geometry of the preform article 115 of FIG. 3 shows a tapered neck 114, and a main body portion 102 with side walls 101 and 104 that are approximately parallel to each other along their length. Furthermore, a closed end portion 116 tapers from the main body portion 102. Threads 110 are provided adjacent the open end 103 of preform article 115. A transition area 105 represents the tapering region of the side wall 101 into the neck 114.

In FIG. 4, a preform article 115 of the invention is shown in which the outer wall surfaces 109a-b of the preform article are generally parallel and straight, forming a substantially symmtrical tube on its outer dimension from a point near the dosed end 116 to a point near the open end 103. The inner wall 108 of the preform 115 is profiled due to a transition zone 105. When blown in stage two of manufacture, the preform article 115 engages a mold so as to make a container 10 of the appropriate geometry.

By “profiled”, it is meant that a given wall has a changing angle or slope which deviates from 180 degrees. Thus, the invention may in some embodiments take advantage of a profiled inner wall 108, as opposed to a profiled exterior wall, as is common in the conventional devices (see FIGS. 3-3A). The use of a profiled inner wall 108 has been found to be a useful feature in application of the preform 115 to container 10 manufacture. One reason for this fact is that it facilitates the use of relatively uniform outer wall dimensions. Thus, preforms 115 can be used that have differing inner wall 108 profile for various container sizes, while still exhibiting a common outer dimension or shape. This is useful in manufacturing, to avoid or minimize tooling and/or machinery changes for each size preform 115 that may be used to make containers 10 of various sizes.

Thus, a relatively uniform outer dimension to the preform articles 115 may provide an advantage that may be realized in the practice of the invention. It should be recognized that the use of a profiled inner wall 108 is not required in the practice of the invention, but is one useful manner of practicing the invention. Thus, preforms having either an exterior profile or an exterior profile may be used in the practice of the invention.

### Injection Molding of Preforms

FIG. 5 shows a schematic vertical cross-sectional view of an injection molding machine for making preform articles in a first stage. A preform article 115 may be formed in an injection molding unit 120 having a barrel 121 fed by an hopper 122 and ejecting the melt through a round nose nozzle 123. A chemical composition (i.e. polypropylene-containing pellets or portions, with optional additives or optional nucleating agents, etc) is provided into inlet hopper 122. Barrel 121 rotatably mounts a melting and mixing screw 124 with a non-return valve nose 125. Heater bands 126 may be provided in the barrel 121. Crystalline polypropylene stretch blow mold formulations are fed through the hopper 122 into the barrel 121 where they are advanced by the melting and mixing screw 124 to a molten condition at the valve end 125 whereupon the screw is advanced to the dotted line position where the valve nose 125 will force the molten material through the nozzle orifice 127. Gate 137a received a determined the amount of liquid flow that proceeds into the molding cavity 135. Other similar apparatus could be used to form a preform, which achieves the same or similar result as that shown in FIG. 5.

The apparatus includes a two-part mold 130 with a first core part 131 and a second molding cavity defining part 132. The part 131 has a cylindrical core 133 with a hemispherical end 134. The part 132 has a molding cavity 135 with a hemispherical bottom end 136 fed by a conduit 137. The end wall of the part 132 has a recess 138 receiving the rounded nose of the nozzle 123.

With the apparatus in the position of FIG. 4 the molten plastics material ahead of the valve 125 may be ejected through the orifice 127 by moving the screw rod to the dotted line position as shown in FIG. 5. The molten material will flow through the conduit 137 into the mold cavity 135.

The surface of core 133 and the molding cavity surfaces 135 and 136 typically are polished, but may be treated as well to facilitate the ejection of preforms 115. Steel is a desired metal for manufacture of such mold surfaces 135. Chilled mold temperatures from about 11-20 degrees C. may be employed.

One feature employed when injection molding preform articles 115, as shown in FIG. 5, is the Gate 137a. The gate 137a refers is the opening between the point at which the liquid polypropylene is injected and the actual core 134 of the mold cavity 135. Gate size is a parameter that may vary for different applications. The size of the gate 137a can be important in the manufacture of preformed articles 115. This is because the size of the gate 137a determines the shear forces applied to the molten polypropylene as it is injected into the mold cavity. The size of gate 137a will affect the filing rate. The size of the gate 137a will in some cases determine the rate by at which the chemical composition may be injected, which affects the ultimate clarity of the containers 10 produced by the preformed article 115 in the second stage of the container 10 manufacture (see FIG. 2B).

To improve the economics of making polypropylene preforms, it may be important to inject chemical compositions quickly (shorter preform cycle time) into the mold cavity 135. However, when injecting quickly, the clarity of the container 10 produced may be compromised because of the characteristics imparted to the preform article 115 during such mold fill step. Thus, using a relatively wide or large gate 37a allows one to inject at a faster rate while still achieving the same or sufficient clarity in the final container. In some applications, this is desirable. Gate diameter may vary, depending upon the application. The invention is not limited to any particular gate diameter, but it has been found that diameters between about 1.5 mm and about 3.8 mm are useful, and may be found in equipment in the industry. It may be an advantage in the practice of the invention to be capable of employing gate diameter settings that already are in existence and used on existing commercial PET processing equipment.

The injection rate usually is relatively slow. Cavity filling time is typically about 1 to about 4.5 total seconds to fill mold cavity 135. This corresponds generally to an injection rate greater than about 5 grams/second. In other cases, the rate may be between about 5 and about 22 grams per second. Table A shows various parameters that may be advantageously employed in the practice of the invention.

Upon solidification of the preform article 115 in the mold 130, the mold 130 is opened by withdrawing part 131 (and core 133) from part 132. The preform 115 is stripped from the mold.

### Melt Flow Index (MFI)

The melt flow index (MFI), also known as the melt flow rate, is an important factor in the manufacturing of preform articles 115. In general, meltflow index is measured according to American Society of Testing Materials ASTM D-1238. This testing method is a nationally (or internationally) known standard. It is a standard test method for measuring the melt flow rates of thermoplastics. Unless otherwise indicated herein, all references to melt flow index, melt flow rate, MFI, or MFR, refer to measurements according to this industry standard. For polypropylene, measurements are at 230 degrees C., and using 2.16 kg, as per this standard.

In general, the more viscous is a material at a given temperature, the lower will be the MFI value of that material. For example, a given polymer or copolymer composition will have an MFI that is specified by a manufacturer. Thus, each particular type of polypropylene-containing composition to be employed in the practice of the invention will have a given or predetermined MFI. The MFI is also determined and affected by the length of the polymer chains in a given polypropylene composition. The longer the polymeric chains, the more viscous the material. The more viscous the material, the lower the MFI value will be for a given composition.

MFI values are important in determining the speed at which a chemical composition may be fed into an injection mold cavity to form a preform article. This is true because the MFI also will affect the clarity of the final container which is produced from the preform. By clarity, it is meant the degree of haze that will be present in a given container 10 made according to the invention. In general, the higher percentage of haze in the container 10, the less transparent is the container 10 produced in the invention. Higher levels of haze are undesirable.

One unexpected result of the invention is that it has been found that using a given polymeric composition having a predetermined melt flow index, and injecting that composition at a fill rate of greater than about 5 grams per second, a highly desired preform article may be formed. Furthermore, it has been found that the sidewall thickness of the preform is very important in container manufacture. In the practice of the invention, a preform article 115 with a side wall thickness of less than about 3.5 millimeters has proved to be very desirable. This achieves a high productivity of container manufacture while still maintaining a low degree of haze, i.e. a clear container. Cycle time necessary to make a preform article 115 is significantly reduced by using a preform design with a minimum side wall thickness. Hot plastic (polypropylene) is capable of cooling in the preform mold more quickly using a reduced wall thickness for the preform stage. This facilitates faster preform cycle times, thereby increasing the number of preform articles 115 that can be made in a given period of time, increasing manufacturing capacity and efficiency.

### Stretch Blow Molding Preform Articles to Form Containers

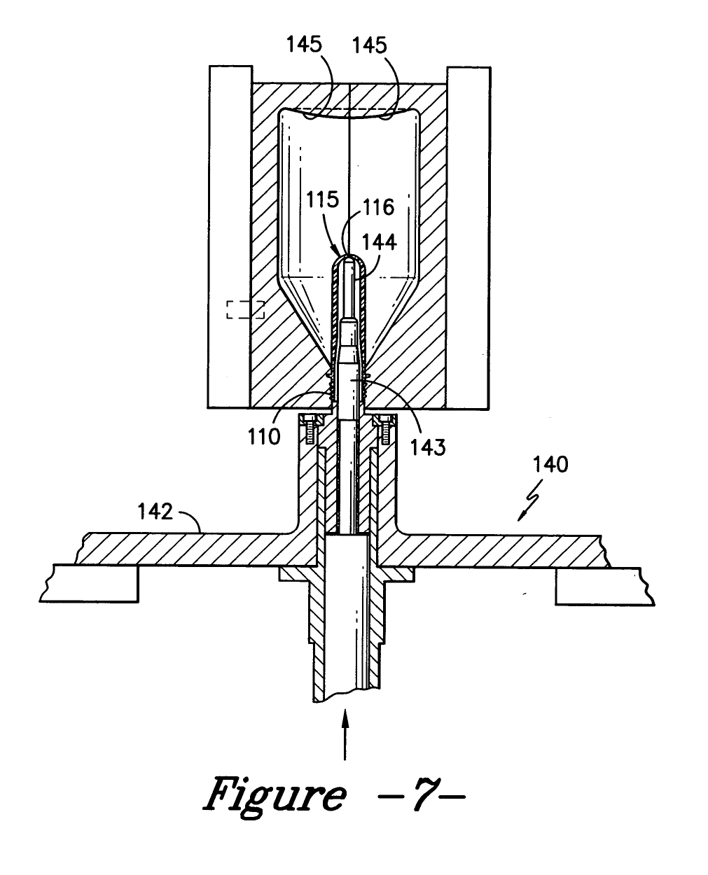

Stage two (step 2) of manufacture is shown generally in FIG. 2B, and FIGS. 6-8. A preform article 115, is taken at ambient temperature, and then uniformly heated. The preform article 115 is placed in a stretch blow mold apparatus 140 in a position with its open end 103 resting on a platform 141 on a base 142 surrounding a reciprocal swage 143. The closed end 116 of the preform 115 is shown near the center of FIG. 6. The apparatus freely receives the retracted end of the stretch rod 144 of the apparatus 140. The molding dies 145 of the apparatus 140 are in an opened condition. Threaded neck forming wall portions 146 are shown, as well as tapered cone forming portions 147, cylindrical main body forming portions 148, and concave bottom forming portions 149.

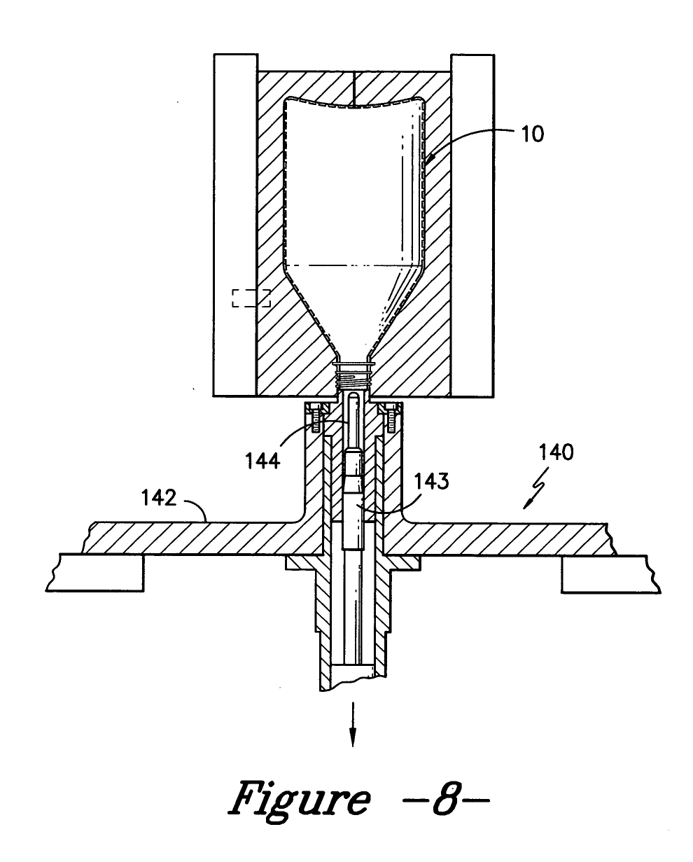

Alternatively, and in some embodiments, it may be that a rotary system is employed to transfer preforms using transfer wheels equipped with grippers into a blow mold cavity. Thus, rotary stretch blow molding equipment is known in the art, and may be applied in the practice of the invention. From the open position of FIG. 6 the apparatus 140 is closed to the position of FIG. 7 with the mold halves 145 coming together and with the swage 143 extended into the open end of the preform 115 so that the neck and thread forming portions 146 of the die can mold the thick neck 114 of the bottle on the preform 115. The projection of the swage 143 into the position of FIG. 7 also moves the stretch rod 144 against the closed end 116 of the preform 115.

From the position of FIG. 7 the apparatus 140 is further activated to eject the stretch rod 144 beyond the swage 143 into closely spaced relation from the bottom forming portion 149 of the dies 145 thereby effecting a stretching of the preform 115 to the full height of the dies. As shown in FIG. 8, the stretch rod 144 and the swage 143 are retracted from the container 10. The gas pressure in the bottle is released, and the dies 45 are separated. A blowing agent is introduced into the preform article 115 forming an axially elongated and hoop stretched balloon in the closed die. The balloon (not shown) is blown into a finished container 10, as shown in FIG. 8, with the polypropylene material biaxially stretched to produce a strong container 10.

Roughness on the inner container 10 surface has a negative influence on the container clarity. If, during reheating of the preform 115 (within the window of process stability), the temperature in the skin-layer (at the side of the core) is insufficiently high, the material undesirably may be ruptured apart during the stretch blow molding (stage two) process, resulting in a rough inner container 10 surface and containers 10 having low clarity. Additionally, it has been observed that a low amount of “pre-blowing” (intermediate shape of the stretched and pre-blown preform part, i.e. before the final pressure is applied) may contribute to a relatively rough inner container 10 surface (i.e. undesirable high haze) for the same reason. More specifically the primary pressure, flow of air and pre-blow time usually need to be sufficiently high to prevent that the material gets ruptured apart what gives the part an undesirable high haze.

### Correlation of Processing Parameters

In the practice of the invention, it is important that several variables and factors be correlated to each other. Variables that are important in the practice of the invention include, for example, injection speed, MFI of the polypropylene-containing resin, the preform article thickness. In some instances, the gate diameter used during injection of the preform article is a factor. These factors may be optimized and correlated to each other for a given container application. It is possible using the practice of the invention to maximize productivity of the preform and to maximize productivity polypropylene containers in a two-stage stretch blow molding process.

In one particularly useful aspect of the invention, a preform thickness may be of a value less than about 3.5 mm. Thickness is measured along sidewalls 101, 104 as shown in FIG. 4A, measured as the maximum or thickest portion of the side wall. In yet another embodiment of the invention, the preform thickness may be in the range of about 2-3.5 mm. Furthermore, in the practice of the invention it has been found that an injection fill rate into the cavity mold of greater than about 5 grams of chemical composition (resin) per second is quite useful. Furthermore, in other aspects of the invention it is advantageous to use a cavity mold fill rate of between 5 and 22 grams per second.

Table A shows a correlation between processing variables in the practice of the invention. In Table A, the MFI values and preform wall thickness values are correlated to the optimized injection mold filling rate in the practice of the invention. It is important to note in Table A that for a given preform wall thickness an increase in the MFI value allows an operator to use a higher injection mold filling rate while still obtaining containers 10 of sufficient clarity. Thus, as a result of the practice of the invention it is possible to reduce the cycle time as compared to prior art processes, and yet still obtain containers of relatively low haze and high quality.

Looking from left to right in Table A, a greater preform wall thickness at a given level of MFI value enables an operator employing the invention to use an injection mold filling rate which is greater, resulting in faster production, reduced cycle times, and good container clarity.

Table A reports values for a (valve) gate thickness of 1.5 mm. In the practice of the invention, the use of a wider gate such as about 3.8 mm can result in a filling rate of about 13 g/sec at a MFI value of 13. This compares to the data in Table A in which a MFI of 13 at a (valve) gate diameter of 1.5 mm was successfully employed using an injection speed of about 5-6 g/sec. Furthermore, it has been found in the practice of the invention that using a (valve) gate diameter of 3.8 mm at MFI value 20 may result in an injection speed of about 22 g/sec. This value of 22 g/sec may be compared to the injection speed shown in Table A (valve diameter 1.5 mm) of 5-7 g/s.

TABLE A
Processing Variables Correlated to Injection
Mold Filling Rate for Invention*

| | Preform Wall Thickness | | | |
|---|---|---|---|---|
| MFI | | 2 mm | 3 mm | 4 mm |

| 1.5 | Poor Clarity | | Poor Clarity | | Poor Clarity | |
|---|---|---|---|---|---|---|
| 13 | 4-5 | g/s | 4-5 | g/s | 5-6 | g/s |
| 20 | 5 | g/s | 5-7 | g/s | 7-10 | g/s |
| 30 | 6-7 | g/s | 10-13 | g/s | 13-17 | g/s |

| | | | | | |
|---|---|---|---|---|---|
| 45 | 11 | g/s | 20 | g/s | N/A |

*Values in Table A are provided for a (valve) gate diameter of 1.5 mm.

Measurements of percent haze/thickness ratios have been obtained on various containers 10 in the practice of the invention. It has been found that a percent haze/thickness reported as percent haze/mils with a value of less than about 0.05 is particularly highly desirable.

In the practice of the invention, it is possible in a manufacturing operation to achieve a rate of container production of greater than about 900 containers per hour per mold. In other applications, it is possible to provide a stretch blow molding step in a manufacturing operation at a rate of container production of at least about 1200 containers per hour per mold. In an even more desirable aspect, the invention makes it possible to achieve a rate of container production of at least about 1500 containers per hour per mold.

The following examples illustrate preferred specific details of the above described blow molding processes for producing clear, transparent, glossy containers (“bottles”) from polypropylene-containing preforms.

### EXAMPLE 1

### 38 mm Neck, 4 mm Wall Preforms

Commercial random copolymer resins containing Millad 3988 (Borealis) were used to produce preforms as indicated in Table I. The preforms were produced on a two-cavity mold (only one cavity installed) 100 ton Netstal injection molding machine with a variable injection time (0.54.0 sec) and a constant cooling time of 22 sec. Melt temperature was 230° C. Temperature of the cooling water was 13° C. The holding pressure time was 9.2 sec. Total cycle time was around 37 sec (not optimized). A valve gate with a diameter of 1.5 mm was used. The preforms have a wall thickness of 4 mm and a bottle weight of about 25.3 g. These preforms were later blown into bottles as explained in subsequent examples.

TABLE I
Example 1 Preforms

| | | MFI | Injection | Injection |
|---|---|---|---|---|
| | | (g/10 | Time | Speed |
| Example | Resin | sec) | (sec) | (g/cc) |
| I-1 | RB307MO | 1.5 | 0.5 | 50.6 |
| I-2 | RB307MO | 1.5 | 1.0 | 25.3 |
| I-3 | RB307MO | 1.5 | 1.5 | 16.9 |
| I-4 | RB307MO | 1.5 | 2.0 | 12.7 |
| I-5 | RB307MO | 1.5 | 2.5 | 10.1 |
| I-6 | RB307MO | 1.5 | 3.0 | 8.4 |
| I-7 | RB307MO | 1.5 | 3.5 | 7.2 |
| I-8 | RB307MO | 1.5 | 4.0 | 6.3 |
| I-9 | RE420MO | 13 | 0.5 | 50.6 |
| I-10 | RE420MO | 13 | 1.0 | 25.3 |
| I-11 | RE420MO | 13 | 1.5 | 16.9 |
| I-12 | RE420MO | 13 | 2.0 | 12.7 |
| I-13 | RE420MO | 13 | 2.5 | 10.1 |
| I-14 | RE420MO | 13 | 3.0 | 8.4 |
| I-15 | RE420MO | 13 | 3.5 | 7.2 |
| I-16 | RE420MO | 13 | 4.0 | 6.3 |
| I-17 | RF365MO | 20 | 0.5 | 50.6 |
| I-18 | RF365MO | 20 | 1.0 | 25.3 |
| I-19 | RF365MO | 20 | 1.5 | 16.9 |
| I-20 | RF365MO | 20 | 2.0 | 12.7 |
| I-21 | RF365MO | 20 | 2.5 | 10.1 |
| I-22 | RF365MO | 20 | 3.0 | 8.4 |
| I-23 | RF365MO | 20 | 3.5 | 7.2 |
| I-24 | RF365MO | 20 | 4.0 | 6.3 |
| I-25 | RG460MO | 30 | 0.5 | 50.6 |
| I-26 | RG460MO | 30 | 1.0 | 25.3 |
| I-27 | RG460MO | 30 | 1.5 | 16.9 |
| I-28 | RG460MO | 30 | 2.0 | 12.7 |
| I-29 | RG460MO | 30 | 2.5 | 10.1 |
| I-30 | RG460MO | 30 | 3.0 | 8.4 |
| 1-31 | RG460MO | 30 | 3.5 | 7.2 |
| I-32 | RG460MO | 30 | 4.0 | 6.3 |
| I-33 | RJ370MO | 45 | 0.5 | 50.6 |
| I-34 | RJ370MO | 45 | 1.0 | 25.3 |
| I-35 | RJ370MO | 45 | 1.5 | 16.9 |
| I-36 | RJ370MO | 45 | 2.0 | 12.7 |
| I-37 | RJ370MO | 45 | 2.5 | 10.1 |
| I-38 | RJ370MO | 45 | 3.0 | 8.4 |
| I-39 | RJ370MO | 45 | 3.5 | 7.2 |
| I-40 | RJ370MO | 45 | 4.0 | 6.3 |

### EXAMPLE 2

### 38 mm Neck, 3 mm Wall Preforms

Commercial random copolymer resins containing Millad 3988 (Borealis) were used to produce preforms as indicated in Table II. The preforms were produced on a two-cavity mold (only one cavity installed) 100 ton Netstal injection molding machine with a variable injection time (0.54.0 sec) and a constant cooling time of 10 sec. Melt temperature was 230° C. Temperature of the cooling water was 13° C. The holding pressure time was 4.5 sec. Total cycle time was around 20 sec (not optimized). A valve gate with a diameter of 1.5 mm was used. The preforms have a wall thickness of 3 mm and a bottle weight of about 20.3 g. These preforms were later blown into bottles as explained in subsequent examples.

TABLE II
Example 2 Preforms

| | | | Injection | Injection |
|---|---|---|---|---|
| | | MFI(g/10 | Time | Speed |
| Example | Resin | sec) | (sec) | (g/cc) |
| II-1 | RB307MO | 1.5 | 0.5 | 40.6 |
| II-2 | RB307MO | 1.5 | 1.0 | 20.3 |
| II-3 | RB307MO | 1.5 | 1.5 | 13.5 |
| II-4 | RB307MO | 1.5 | 2.0 | 10.2 |
| II-5 | RB307MO | 1.5 | 2.5 | 8.1 |
| II-6 | RB307MO | 1.5 | 3.0 | 6.8 |
| II-7 | RB307MO | 1.5 | 3.5 | 5.8 |
| II-8 | RB307MO | 1.5 | 4.0 | 5.1 |
| II-9 | RE420MO | 13 | 0.5 | 40.6 |
| II-10 | RE420MO | 13 | 1.0 | 20.3 |
| II-11 | RE420MO | 13 | 1.5 | 13.5 |
| II-12 | RE420MO | 13 | 2.0 | 10.2 |
| II-13 | RE420MO | 13 | 2.5 | 8.1 |
| II-14 | RE420MO | 13 | 3.0 | 6.8 |
| II-15 | RE420MO | 13 | 3.5 | 5.8 |
| II-16 | RE420MO | 13 | 4.0 | 5.1 |
| II-17 | RF365MO | 20 | 0.5 | 40.6 |
| II-18 | RF365MO | 20 | 1.0 | 20.3 |
| II-19 | RF365MO | 20 | 1.5 | 13.5 |
| II-20 | RF365MO | 20 | 2.0 | 10.2 |
| II-21 | RF365MO | 20 | 2.5 | 8.1 |
| II-22 | RF365MO | 20 | 3.0 | 6.8 |
| II-23 | RF365MO | 20 | 3.5 | 5.8 |
| II-24 | RF365MO | 20 | 4.0 | 5.1 |
| II-25 | RG460MO | 30 | 0.5 | 40.6 |
| II-26 | RG460MO | 30 | 1.0 | 20.3 |
| II-27 | RG460MO | 30 | 1.5 | 13.5 |
| II-28 | RG460MO | 30 | 2.0 | 10.2 |
| II-29 | RG460MO | 30 | 2.5 | 8.1 |
| II-30 | RG460MO | 30 | 3.0 | 6.8 |
| II-31 | RG460MO | 30 | 3.5 | 5.8 |
| II-32 | RG460MO | 30 | 4.0 | 5.1 |
| II-33 | RJ370MO | 45 | 0.5 | 40.6 |
| II-34 | RJ370MO | 45 | 1.0 | 20.3 |
| II-35 | RJ370MO | 45 | 1.5 | 13.5 |
| II-36 | RJ370MO | 45 | 2.0 | 10.2 |
| II-37 | RJ370MO | 45 | 2.5 | 8.1 |
| II-38 | RJ370MO | 45 | 3.0 | 6.8 |
| II-39 | RJ370MO | 45 | 3.5 | 5.8 |
| II-40 | RJ370MO | 45 | 4.0 | 5.1 |

### EXAMPLE 3

### 38 mm Neck, 2 mm Wall Preforms

Commercial random copolymer resins containing Millad 3988 (Borealis) were used to produce preforms as indicated in Table III. The preforms were produced on a two-cavity mold (only one cavity installed) 100 ton Netstal injection molding machine with a variable injection time (0.54.0 sec) and a constant cooling time of 10 sec. Melt temperature was 230° C. Temperature of the cooling water was 13° C. The holding pressure time was 2 sec. Total cycle time was around 20 sec (not optimized). A valve gate with a diameter of 1.5 mm was used. The preforms have a wall thickness of 2 mm and a bottle weight of about 17.3 g. These preforms were later blown into bottles as explained in subsequent examples.

TABLE III
Example 3 Preforms

| | | MFI | Injection | Injection |
|---|---|---|---|---|
| | | (g/10 | Time | Speed |
| Example | Resin | sec) | (sec) | (g/cc) |
| III-1 | RB307MO | 1.5 | 0.5 | 34.6 |
| III-2 | RB307MO | 1.5 | 1.0 | 17.3 |
| III-3 | RB307MO | 1.5 | 1.5 | 11.5 |
| III-4 | RB307MO | 1.5 | 2.0 | 10.2 |
| III-5 | RB307MO | 1.5 | 2.5 | 6.9 |
| III-6 | RB307MO | 1.5 | 3.0 | 5.8 |
| III-7 | RB307MO | 1.5 | 3.5 | 4.9 |
| III-8 | RB307MO | 1.5 | 4.0 | 4.3 |
| III-9 | RE420MO | 13 | 0.5 | 34.6 |
| III-10 | RE420MO | 13 | 1.0 | 17.3 |
| III-11 | RE420MO | 13 | 1.5 | 11.5 |
| III-12 | RE420MO | 13 | 2.0 | 10.2 |
| III-13 | RE420MO | 13 | 2.5 | 6.9 |
| III-14 | RE420MO | 13 | 3.0 | 5.8 |
| III-15 | RE420MO | 13 | 3.5 | 4.9 |
| III-16 | RE420MO | 13 | 4.0 | 4.3 |
| III-17 | RF365MO | 20 | 0.5 | 34.6 |
| III-18 | RF365MO | 20 | 1.0 | 17.3 |
| III-19 | RF365MO | 20 | 1.5 | 11.5 |
| III-20 | RF365MO | 20 | 2.0 | 10.2 |
| III-21 | RF365MO | 20 | 2.5 | 6.9 |
| III-22 | RF365MO | 20 | 3.0 | 5.8 |
| III-23 | RF365MO | 20 | 3.5 | 4.9 |
| III-24 | RF365MO | 20 | 4.0 | 4.3 |
| III-25 | RG460MO | 30 | 0.5 | 34.6 |
| III-26 | RG460MO | 30 | 1.0 | 17.3 |
| III-27 | RG460MO | 30 | 1.5 | 11.5 |
| III-28 | RG460MO | 30 | 2.0 | 10.2 |
| III-29 | RG460MO | 30 | 2.5 | 6.9 |
| III-30 | RG460MO | 30 | 3.0 | 5.8 |
| III-31 | RG460MO | 30 | 3.5 | 4.9 |
| III-32 | RG460MO | 30 | 4.0 | 4.3 |
| III-33 | RJ370MO | 45 | 0.5 | 34.6 |
| III-34 | RJ370MO | 45 | 1.0 | 17.3 |
| III-35 | RJ370MO | 45 | 1.5 | 11.5 |
| III-36 | RJ370MO | 45 | 2.0 | 10.2 |
| III-37 | RJ370MO | 45 | 2.5 | 6.9 |
| III-38 | RJ370MO | 45 | 3.0 | 5.8 |
| III-39 | RJ370MO | 45 | 3.5 | 4.9 |
| III-40 | RJ370MO | 45 | 4.0 | 4.3 |

### EXAMPLE 4

### 38 mm Neck Bottles Produced Using Old ISBM Machine with 4 mm Performs

Polypropylene bottles (330 ml) were on a two-cavity Chia-Ming stretch blow molding machine designed to blow polypropylene bottles from preforms described in Example 1. Axial stretch ratio is 1.9/1, Hoop Stretch ratio=2.5/1 & Total Stretch Ratio=4.8/1. This machine is equipped with 3 heater boxes per cavity & uses 1000 Watt IR lamps. Pre-blow pressure was 6 bar & final pressure was 8 bar. After optimization, the bottle productivity for the preforms with 4 mm thickness was 820 bph/cav. Bottle quality was judged at the time of production to be Unacceptable (poorly blown bottle or blown out), Acceptable (a fully blown bottle with moderate optical properties), Average (a fully blown bottle with improved optical properties), or Excellent (a fully blown bottle with outstanding optical clarity).

TABLE IV
Example 4 Bottles

| | MFI | Injection | | |
|---|---|---|---|---|
| | (g/10 | Speed | % Haze/ | Bottle |
| Example | sec) | (g/cc) | thickness | Quality |
| IV-1 | 1.5 | 50.6 | 1.252 | Acceptable |
| IV-2 | 1.5 | 25.3 | | Acceptable |
| IV-3 | 1.5 | 16.9 | | Acceptable |
| IV-4 | 1.5 | 12.7 | 1.530 | Acceptable |
| IV-5 | 1.5 | 10.1 | | Acceptable |
| IV-6 | 1.5 | 8.4 | | Acceptable |
| IV-7 | 1.5 | 7.2 | | Acceptable |
| IV-8 | 1.5 | 6.3 | | Acceptable |
| IV-9 | 13 | 50.6 | | Acceptable |
| IV-10 | 13 | 25.3 | | Acceptable |
| IV-11 | 13 | 16.9 | | Acceptable |
| IV-12 | 13 | 12.7 | | Acceptable |
| IV-13 | 13 | 10.1 | | Acceptable |
| IV-14 | 13 | 8.4 | | Average |
| IV-15 | 13 | 7.2 | 0.067 | Excellent |
| IV-16 | 13 | 6.3 | 0.043 | Excellent |
| IV-17 | 20 | 50.6 | | Acceptable |
| IV-18 | 20 | 25.3 | | Acceptable |
| IV-19 | 20 | 16.9 | | Acceptable |
| IV-20 | 20 | 12.7 | | Average |
| IV-21 | 20 | 10.1 | 0.782 | Average |
| IV-22 | 20 | 8.4 | | Excellent |
| IV-23 | 20 | 7.2 | | Excellent |
| IV-24 | 20 | 6.3 | 0.036 | Excellent |
| IV-25 | 30 | 50.6 | 1.191 | Acceptable |
| IV-26 | 30 | 25.3 | 0.150 | Acceptable |
| IV-27 | 30 | 16.9 | 0.062 | Excellent |
| IV-28 | 30 | 12.7 | | Excellent |
| IV-29 | 30 | 10.1 | | Excellent |
| IV-30 | 30 | 8.4 | | Excellent |
| IV-31 | 30 | 7.2 | 0.075 | Excellent |
| IV-32 | 30 | 6.3 | | Excellent |
| IV-33 | 45 | 50.6 | | NA |
| IV-34 | 45 | 25.3 | | NA |
| IV-35 | 45 | 16.9 | | NA |
| IV-36 | 45 | 12.7 | | NA |
| IV-37 | 45 | 10.1 | | NA |
| IV-38 | 45 | 8.4 | | NA |
| IV-39 | 45 | 7.2 | | NA |
| IV-40 | 45 | 6.3 | 0.072 | NA |

### EXAMPLE 5

### 38 mm Neck Bottles Produced Using Old ISBM Machine with 3 mm Preforms

Polypropylene bottles (330 ml) were blown at high speed on a two-cavity Chia-Ming stretch blow molding machine designed to blow polypropylene bottles from preforms described in Example 2. Axial stretch ratio is 1.9/1, Hoop Stretch ratio=2.4 & Total Stretch Ratio=4.6/1. This machine is equipped with 3 heater boxes per cavity & uses 1000 Watt IR lamps. Pre-blow pressure was 6 bar & final pressure was 8 bar. After optimization, the bottle productivity for the preforms with 3 mm thickness was 1,030 bph/cav. Bottle quality was judged at the time of production to be Unacceptable (poorly blown bottle or blown out), Acceptable (a fully blown bottle with moderate optical properties), Average (a fully blown bottle with improved optical properties), or Excellent (a fully blown bottle with outstanding optical clarity).

TABLE V
Example 5 Bottles

| | MFI | Injection | | |
|---|---|---|---|---|
| | (g/10 | Speed | % Haze/ | Bottle |
| Example | sec) | (g/cc) | thickness | Quality |
| V-1 | 1.5 | 40.6 | | Acceptable |
| V-2 | 1.5 | 20.3 | | Acceptable |
| V-3 | 1.5 | 13.5 | | Acceptable |
| V-4 | 1.5 | 10.2 | | Acceptable |
| V-5 | 1.5 | 8.1 | | Acceptable |
| V-6 | 1.5 | 6.8 | | Acceptable |
| V-7 | 1.5 | 5.8 | | Acceptable |
| V-8 | 1.5 | 5.1 | 2.143 | Acceptable |
| V-9 | 13 | 40.6 | | Acceptable |
| V-10 | 13 | 20.3 | | Acceptable |
| V-11 | 13 | 13.5 | | Acceptable |
| V-12 | 13 | 10.2 | | Acceptable |
| V-13 | 13 | 8.1 | | Acceptable |
| V-14 | 13 | 6.8 | | Acceptable |
| V-15 | 13 | 5.8 | | Average |
| V-16 | 13 | 5.1 | | Excellent |
| V-17 | 20 | 40.6 | | Acceptable |
| V-18 | 20 | 20.3 | | Acceptable |
| V-19 | 20 | 13.5 | | Acceptable |
| V-20 | 20 | 10.2 | | Average |
| V-21 | 20 | 8.1 | | Average |
| V-22 | 20 | 6.8 | 0.132 | Average |
| V-23 | 20 | 5.8 | | Excellent |
| V-24 | 20 | 5.1 | 0.056 | Excellent |
| V-25 | 30 | 40.6 | 0.125 | Acceptable |
| V-26 | 30 | 20.3 | | Acceptable |
| V-27 | 30 | 13.5 | | Acceptable |
| V-28 | 30 | 10.2 | | Excellent |
| V-29 | 30 | 8.1 | | Excellent |
| V-30 | 30 | 6.8 | | Excellent |
| V-31 | 30 | 5.8 | 0.075 | Excellent |
| V-32 | 30 | 5.1 | | Excellent |
| V-33 | 45 | 40.6 | | Acceptable |
| V-34 | 45 | 20.3 | | Average |
| V-35 | 45 | 13.5 | | Excellent |
| V-36 | 45 | 10.2 | | Excellent |
| V-37 | 45 | 8.1 | | Excellent |
| V-38 | 45 | 6.8 | | Excellent |
| V-39 | 45 | 5.8 | | Excellent |
| V-40 | 45 | 5.1 | | Excellent |

### EXAMPLE 6

### 38 mm Neck Bottles Produced Using Old ISBM Machine with 2 mm Preforms

Polypropylene bottles (330 ml) were blown at high speed on a two-cavity Chia-Ming stretch blow molding machine designed to blow polypropylene bottles from preforms described in Example 3. Axial stretch ratio is 1.9/1, Hoop Stretch ratio=2.4 & Total Stretch Ratio=4.4/1. This machine is equipped with 3 heater boxes per cavity & uses 1000 Watt IR lamps. Pre-blow pressure was 6 bar & final pressure was 8 bar. After optimization, the bottle productivity for the preforms with 2 mm thickness was 1,200 bph/cav. Bottle quality was judged at the time of production to be Unacceptable (poorly blown bottle or blown out), Acceptable (a fully blown bottle with moderate optical properties), Average (a fully blown bottle with improved optical properties), or Excellent (a fully blown bottle with outstanding optical clarity).

TABLE VI
Example 6 Bottles

| | MFI | Injection | | |
|---|---|---|---|---|
| | (g/10 | Speed | % Haze/ | Bottle |
| Example | sec) | (g/cc) | thickness | Quality |
| VI-1 | 1.5 | 34.6 | | Acceptable |
| VI-2 | 1.5 | 17.3 | | Acceptable |
| VI-3 | 1.5 | 11.5 | | Acceptable |
| VI-4 | 1.5 | 10.2 | | Acceptable |
| VI-5 | 1.5 | 6.9 | | Acceptable |
| VI-6 | 1.5 | 5.8 | | Acceptable |
| VI-7 | 1.5 | 4.9 | | Acceptable |
| VI-8 | 1.5 | 4.3 | | Acceptable |
| VI-9 | 13 | 34.6 | | Acceptable |
| VI-10 | 13 | 17.3 | | Acceptable |
| VI-11 | 13 | 11.5 | | Acceptable |
| VI-12 | 13 | 10.2 | | Acceptable |
| VI-13 | 13 | 6.9 | | Acceptable |
| VI-14 | 13 | 5.8 | | Acceptable |
| VI-15 | 13 | 4.9 | | Acceptable |
| VI-16 | 13 | 4.3 | | Average |
| VI-17 | 20 | 34.6 | | Acceptable |
| VI-18 | 20 | 17.3 | | Acceptable |
| VI-19 | 20 | 11.5 | | Acceptable |
| VI-20 | 20 | 10.2 | | Acceptable |
| VI-21 | 20 | 6.9 | | Acceptable |
| VI-22 | 20 | 5.8 | | Average |
| VI-23 | 20 | 4.9 | | Excellent |
| VI-24 | 20 | 4.3 | | Excellent |
| VI-25 | 30 | 34.6 | | Acceptable |
| VI-26 | 30 | 17.3 | | Acceptable |
| VI-27 | 30 | 11.5 | | Acceptable |
| VI-28 | 30 | 10.2 | | Acceptable |
| VI-29 | 30 | 6.9 | | Excellent |
| VI-30 | 30 | 5.8 | | Excellent |
| VI-31 | 30 | 4.9 | | Excellent |
| VI-32 | 30 | 4.3 | | Excellent |
| VI-33 | 45 | 34.6 | | Acceptable |
| VI-34 | 45 | 17.3 | | Average |
| VI-35 | 45 | 11.5 | | Excellent |
| VI-36 | 45 | 10.2 | | Excellent |
| VI-37 | 45 | 6.9 | | Excellent |
| VI-38 | 45 | 5.8 | | Excellent |
| VI-39 | 45 | 4.9 | | Excellent |
| VI-40 | 45 | 4.3 | 0.087 | Excellent |

### EXAMPLE 7

### 38 mm Neck Bottles Produced Using New ISBM Machine with 4 mm Preforms

Polypropylene bottles (500 ml) were blown at high speed (1500 bottles/cavity/hour) on a Sidel SBO-8 Series II stretch blow molding machine designed to blow PET preforms using the polypropylene preforms described in Example 1. Axial stretch ratio is 2.5/1, Hoop Stretch ratio=2.63 & Total Stretch Ratio=6.57/1. Machine settings were adjusted to accommodate high clarity, high speed bottle production. Preforms were subjected to a pre-blow pressure of 3 Bar for 0.9 seconds with the preform inner temperature set to about 1250-130° C. and the outer temperature set to about 1200-125° C. Heating power distribution was managed in the range of 90%. Bottle quality was judged at the time of production to be Unacceptable (poorly blown bottle or blown out), Acceptable (a fully blown bottle with moderate optical properties), Average (a fully blown bottle with improved optical properties), or excellent (a fully blown bottle with outstanding optical clarity).

TABLE VII
Example 7 Bottles

| | MFI | Injection | | |
|---|---|---|---|---|
| | (g/10 | Speed | % Haze/ | Bottle |
| Example | sec) | (g/cc) | thickness | Quality |
| VII-1 | 1.5 | 50.6 | | Acceptable |
| VII-2 | 1.5 | 25.3 | | Acceptable |
| VII-3 | 1.5 | 16.9 | | Acceptable |
| VII-4 | 1.5 | 12.7 | | Acceptable |
| VII-5 | 1.5 | 10.1 | | Acceptable |
| VII-6 | 1.5 | 8.4 | | Acceptable |
| VII-7 | 1.5 | 7.2 | | Acceptable |
| VII-8 | 1.5 | 6.3 | 1.500 | Acceptable |
| VII-9 | 13 | 50.6 | | Acceptable |
| VII-10 | 13 | 25.3 | | Acceptable |
| VII-11 | 13 | 16.9 | 1.474 | Acceptable |
| VII-12 | 13 | 12.7 | 0.494 | Acceptable |
| VII-13 | 13 | 10.1 | 0.283 | Average |
| VII-14 | 13 | 8.4 | 0.205 | Average |
| VII-15 | 13 | 7.2 | 0.075 | Excellent |
| VII-16 | 13 | 6.3 | 0.089 | Excellent |
| VII-17 | 20 | 50.6 | | Acceptable |
| VII-18 | 20 | 25.3 | 0.895 | Acceptable |
| VII-19 | 20 | 16.9 | 0.250 | Acceptable |
| VII-20 | 20 | 12.7 | 0.111 | Acceptable |
| VII-21 | 20 | 10.1 | 0.467 | Acceptable |
| VII-22 | 20 | 8.4 | 0.211 | Average |
| VII-23 | 20 | 7.2 | 0.086 | Excellent |
| VII-24 | 20 | 6.3 | 0.068 | Excellent |
| VII-25 | 30 | 50.6 | | Acceptable |
| VII-26 | 30 | 25.3 | | Acceptable |
| VII-27 | 30 | 16.9 | | Average |
| VII-28 | 30 | 12.7 | 0.079 | Excellent |
| VII-29 | 30 | 10.1 | | Excellent |
| VII-30 | 30 | 8.4 | | Excellent |
| VII-31 | 30 | 7.2 | | Excellent |
| VII-32 | 30 | 6.3 | 0.068 | Excellent |
| VII-33 | 45 | 50.6 | | Excellent |
| VII-34 | 45 | 25.3 | | Excellent |
| VII-35 | 45 | 16.9 | | Excellent |
| VII-36 | 45 | 12.7 | | Excellent |
| VII-37 | 45 | 10.1 | | Excellent |
| VII-38 | 45 | 8.4 | | Excellent |
| VII-39 | 45 | 7.2 | | Excellent |
| VII-40 | 45 | 6.3 | | Excellent |

### EXAMPLE 8

### 38 mm Neck Bottles Produced Using New ISBM Machine with 3 mm Performs

Polypropylene bottles (500 ml) were blown at high speed (1,500 bottles/cavity/hour) on a Sidel SBO-8 Series-11 stretch blow molding machine designed to blow PET preforms using the polypropylene preforms described in Example 2. Axial stretch ratio is 2.5/1, Hoop Stretch ratio=2.54 & Total Stretch Ratio=6.36/1. Machine settings were adjusted to accommodate high clarity, high speed bottle production. Preforms were subjected to a pre-blow pressure of 4.5 Bar for 0.4 seconds & nozzle for 3 rotations open activated at ‘point zero’. Blowing time is 0.8 sec & Exhaust time is 0.4 sec. Stretch speed is 1,384 m/sec & a standard stretch rod with 14 mm diameter was used. Preform temperature is about 120-130° C. Heating profile: Z1=75%, Z2=90%, Z3=70%, Z4=70%, Z5=65% & Z6=70% with Z1, Z5 & Z6 in an advanced position. % GP 65%. This example used 100% was ventilation to cool the preform surface. Total heating time, 14.65 sec, stabilization time=6.0 sec & final stabilization time=4.5 sec. Bottle quality was judged at the time of production to be Unacceptable (poorly blown bottle or blown out), Acceptable (a fully blown bottle with moderate optical properties), Average (a fully blown bottle with improved optical properties), or Excellent (a fully blown bottle with outstanding optical clarity).

TABLE VIII
Example 8 Bottles

| | MFI | Injection | | |
|---|---|---|---|---|
| | (g/10 | Speed | % Haze/ | Bottle |
| Example | sec) | (g/cc) | thickness | Quality |
| VIII-1 | 1.5 | 40.6 | | Acceptable |
| VIII-2 | 1.5 | 20.3 | | Acceptable |
| VIII-3 | 1.5 | 13.5 | | Acceptable |
| VIII-4 | 1.5 | 10.2 | | Acceptable |
| VIII-5 | 1.5 | 8.1 | | Acceptable |
| VIII-6 | 1.5 | 6.8 | | Acceptable |
| VIII-7 | 1.5 | 5.8 | | Acceptable |
| VIII-8 | 1.5 | 5.1 | 1.316 | Acceptable |
| VIII-9 | 13 | 40.6 | | Acceptable |
| VIII-10 | 13 | 20.3 | | Acceptable |
| VIII-11 | 13 | 13.5 | | Acceptable |
| VIII-12 | 13 | 10.2 | | Acceptable |
| VIII-13 | 13 | 8.1 | | Acceptable |
| VIII-14 | 13 | 6.8 | | Acceptable |
| VIII-15 | 13 | 5.8 | 0.087 | Average |
| VIII-16 | 13 | 5.1 | 0.074 | Excellent |
| VIII-17 | 20 | 40.6 | | Acceptable |
| VIII-18 | 20 | 20.3 | | Acceptable |
| VIII-19 | 20 | 13.5 | | Acceptable |
| VIII-20 | 20 | 10.2 | 0.153 | Average |
| VIII-21 | 20 | 8.1 | | Average |
| VIII-22 | 20 | 6.8 | | Excellent |
| VIII-23 | 20 | 5.8 | | Excellent |
| VIII-24 | 20 | 5.1 | 0.084 | Excellent |
| VIII-25 | 30 | 40.6 | | Acceptable |
| VIII-26 | 30 | 20.3 | | Acceptable |
| VIII-27 | 30 | 13.5 | 0.094 | Average |
| VIII-28 | 30 | 10.2 | | Excellent |
| VIII-29 | 30 | 8.1 | | Excellent |
| VIII-30 | 30 | 6.8 | | Excellent |
| VIII-31 | 30 | 5.8 | | Excellent |
| VIII-32 | 30 | 5.1 | 0.082 | Excellent |
| VIII-33 | 45 | 40.6 | | Acceptable |
| VIII-34 | 45 | 20.3 | 0.192 | Average |
| VIII-35 | 45 | 13.5 | | Excellent |
| VIII-36 | 45 | 10.2 | | Excellent |
| VIII-37 | 45 | 8.1 | | Excellent |
| VIII-38 | 45 | 6.8 | | Excellent |
| VIII-39 | 45 | 5.8 | | Excellent |
| VIII-40 | 45 | 5.1 | 0.072 | Excellent |

### EXAMPLE 9

### 38 mm Neck Bottles Produced Using New ISBM Machine with 2 mm Preforms

Polypropylene bottles (500 ml) were blown at high speed (1,500 bottles/cavity/hour) on a Sidel SBO-8 Series-II stretch blow molding machine designed to blow PET preforms using the polypropylene preforms described in Example 3. Axial stretch ratio is 2.5/1, Hoop Stretch ratio=2.54 & Total Stretch Ratio=6.36/1. Machine settings were adjusted to accommodate high clarity, high speed bottle production. Preforms were subjected to a pre-blow pressure of 4 Bar for 0.4 seconds & nozzle for 3 rotations open activated at ‘point zero’. Blowing time is 0.8 sec & Exhaust time is 0.4 sec. Stretch speed is 1,384 m/sec & a standard stretch rod with 14 mm diameter was used. Preform temperature is about 115-127° C. Heating profile: Z1=72.5%, Z2=26%, Z3=26%, Z4=32.8%, Z5=26% & Z6=55.5% with Z1, Z5 & Z6 in an advanced position. % GP=45%. Used 100% ventilation to cool the preform surface. Total heating time is 14.65 sec, stabilization time=6.0 sec & final stabilization time=4.5 sec. Bottle quality was judged at the time of production to be Unacceptable (poorly blown bottle or blown out), Acceptable (a fully blown bottle with moderate optical properties), Average (a fully blown bottle with improved optical properties), or Excellent (a fully blown bottle with outstanding optical clarity).

TABLE IX
Example 9 Bottles

| | MFI | | | |
|---|---|---|---|---|
| | (g/10 | Injection | % Haze/ | Bottle |
| Example | sec) | Speed(g/cc) | thickness | Quality |
| IX-1 | 1.5 | 34.6 | 3.462 | Acceptable |
| IX-2 | 1.5 | 17.3 | 2.722 | Acceptable |
| IX-3 | 1.5 | 11.5 | 2.300 | Acceptable |
| IX-4 | 1.5 | 10.2 | 2.053 | Acceptable |
| IX-5 | 1.5 | 6.9 | 2.250 | Acceptable |
| IX-6 | 1.5 | 5.8 | 2.000 | Acceptable |
| IX-7 | 1.5 | 4.9 | 2.000 | Acceptable |
| IX-8 | 1.5 | 4.3 | 1.824 | Acceptable |
| IX-9 | 13 | 34.6 | 2.537 | Acceptable |
| IX-10 | 13 | 17.3 | 1.739 | Acceptable |
| IX-11 | 13 | 11.5 | 1.833 | Acceptable |
| IX-12 | 13 | 10.2 | 0.545 | Acceptable |
| IX-13 | 13 | 6.9 | 0.154 | Acceptable |
| IX-14 | 13 | 5.8 | 0.146 | Acceptable |
| IX-15 | 13 | 4.9 | 0.160 | Acceptable |
| IX-16 | 13 | 4.3 | 0.115 | Average |
| IX-17 | 20 | 34.6 | 2.591 | Acceptable |
| IX-18 | 20 | 17.3 | 1.250 | Acceptable |
| IX-19 | 20 | 11.5 | 2.000 | Acceptable |
| IX-20 | 20 | 10.2 | 1.077 | Acceptable |
| IX-21 | 20 | 6.9 | 0.200 | Acceptable |
| IX-22 | 20 | 5.8 | 0.107 | Average |
| IX-23 | 20 | 4.9 | 0.186 | Average |
| IX-24 | 20 | 4.3 | | Excellent |
| IX-25 | 30 | 34.6 | | Acceptable |
| IX-26 | 30 | 17.3 | | Acceptable |
| IX-27 | 30 | 11.5 | | Acceptable |
| IX-28 | 30 | 10.2 | | Average |
| IX-29 | 30 | 6.9 | 0.143 | Average |
| IX-30 | 30 | 5.8 | | Excellent |
| IX-31 | 30 | 4.9 | | Excellent |
| IX-32 | 30 | 4.3 | 0.100 | Excellent |
| IX-33 | 45 | 34.6 | 1.000 | Acceptable |
| IX-34 | 45 | 17.3 | 0.387 | Acceptable |
| IX-35 | 45 | 11.5 | 0.143 | Average |
| IX-36 | 45 | 10.2 | | Excellent |
| IX-37 | 45 | 6.9 | | Excellent |
| IX-38 | 45 | 5.8 | | Excellent |
| IX-39 | 45 | 4.9 | | Excellent |
| IX-40 | 45 | 4.3 | 0.092 | Excellent |

### EXAMPLE 10

### 38 mm Neck, 3 mm Wall Preforms

Several compounds were produced on a Killion single screw extruder at a temperature 230° C. using 0.25 g/10 min random copolymer polypropylene fluff. The preforms (ref. Table X) were produced on a two-cavity mold (only one cavity installed) 100 ton Netstal injection molding machine with a variable injection time (0.5-4.0 sec) and a constant cooling time of 10 sec. Melt temperature was 230° C. Temperature of the cooling water was 13° C. The holding pressure time was 4.5 sec. Total cycle time was around 20 sec (not optimized). A valve gate with a diameter of 1.5 mm was used. The preforms have a wall thickness of 3 mm and a bottle weight of about 20.3 g. These preforms were later blown into bottles as explained in subsequent examples.

TABLE X
Example 10 Preforms

| | | | Injection | Injection |
|---|---|---|---|---|
| | | Loading | Time | Speed |
| Example | Nucleator | (ppm) | (sec) | (g/cc) |
| X-1 | NA-21 | 2000 | 0.5 | 50.6 |
| X-2 | NA-21 | 2000 | 1.0 | 25.3 |
| X-3 | NA-21 | 2000 | 1.5 | 16.9 |
| X-4 | NA-21 | 2000 | 2.0 | 12.7 |
| X-5 | NA-21 | 2000 | 2.5 | 10.1 |
| X-6 | NA-21 | 2000 | 3.0 | 8.4 |
| X-7 | NA-21 | 2000 | 3.5 | 7.2 |
| X-8 | NA-21 | 2000 | 4.0 | 6.3 |
| X-9 | NA-11 | 1000 | 0.5 | 50.6 |
| X-10 | NA-11 | 1000 | 1.0 | 25.3 |
| X-11 | NA-11 | 1000 | 1.5 | 16.9 |
| X-12 | NA-11 | 1000 | 2.0 | 12.7 |
| X-13 | NA-11 | 1000 | 2.5 | 10.1 |
| X-14 | NA-11 | 1000 | 3.0 | 8.4 |
| X-15 | NA-11 | 1000 | 3.5 | 7.2 |
| X-16 | NA-11 | 1000 | 4.0 | 6.3 |
| X-17 | HPN-68 | 1000 | 0.5 | 50.6 |
| X-18 | HPN-68 | 1000 | 1.0 | 25.3 |
| X-19 | HPN-68 | 1000 | 1.5 | 16.9 |
| X-20 | HPN-68 | 1000 | 2.0 | 12.7 |
| X-21 | HPN-68 | 1000 | 2.5 | 10.1 |
| X-22 | HPN-68 | 1000 | 3.0 | 8.4 |
| X-23 | HPN-68 | 1000 | 3.5 | 7.2 |
| X-24 | HPN-68 | 1000 | 4.0 | 6.3 |
| X-25 | AlptBBA | 1000 | 0.5 | 50.6 |
| X-26 | AlptBBA | 1000 | 1.0 | 25.3 |
| X-27 | AlptBBA | 1000 | 1.5 | 16.9 |
| X-28 | AlptBBA | 1000 | 2.0 | 12.7 |
| X-29 | AlptBBA | 1000 | 2.5 | 10.1 |
| X-30 | AlptBBA | 1000 | 3.0 | 8.4 |
| X-31 | AlptBBA | 1000 | 3.5 | 7.2 |
| X-32 | AlptBBA | 1000 | 4.0 | 6.3 |
| X-33 | CaHHPA | 1500 | 0.5 | 50.6 |
| X-34 | CaHHPA | 1500 | 1.0 | 25.3 |
| X-35 | CaHHPA | 1500 | 1.5 | 16.9 |
| X-36 | CaHHPA | 1500 | 2.0 | 12.7 |
| X-37 | CaHHPA | 1500 | 2.5 | 10.1 |
| X-38 | CaHHPA | 1500 | 3.0 | 8.4 |
| X-39 | CaHHPA | 1500 | 3.5 | 7.2 |
| X-40 | CaHHPA | 1500 | 4.0 | 6.3 |
| X-41 | M3905 | 2000 | 0.5 | 50.6 |
| X-42 | M3905 | 2000 | 1.0 | 25.3 |
| X-43 | M3905 | 2000 | 1.5 | 16.9 |
| X-44 | M3905 | 2000 | 2.0 | 12.7 |
| X-45 | M3905 | 2000 | 2.5 | 10.1 |
| X-46 | M3905 | 2000 | 3.0 | 8.4 |
| X-47 | M3905 | 2000 | 3.5 | 7.2 |
| X-48 | M3905 | 2000 | 4.0 | 6.3 |
| X-49 | M3988 | 2000 | 0.5 | 50.6 |
| X-50 | M3988 | 2000 | 1.0 | 25.3 |
| X-51 | M3988 | 2000 | 1.5 | 16.9 |
| X-52 | M3988 | 2000 | 2.0 | 12.7 |
| X-53 | M3988 | 2000 | 2.5 | 10.1 |
| X-54 | M3988 | 2000 | 3.0 | 8.4 |
| X-55 | M3988 | 2000 | 3.5 | 7.2 |
| X-56 | M3988 | 2000 | 4.0 | 6.3 |
| X-57 | — | — | 0.5 | 50.6 |
| X-58 | — | — | 1.0 | 25.3 |
| X-59 | — | — | 1.5 | 16.9 |
| X-60 | — | — | 2.0 | 12.7 |
| X-61 | — | — | 2.5 | 10.1 |
| X-62 | — | — | 3.0 | 8.4 |
| X-63 | — | — | 3.5 | 7.2 |
| X-64 | | | 4.0 | 6.3 |

### EXAMPLE 11

### 38 mm Neck Bottles Produced Using Old ISBM Machine with 3 mm Preforms

Polypropylene bottles (330 ml, ref. Table XI) were produced blown at high speed on a two-cavity Chia-Ming stretch blow molding machine designed to blow polypropylene bottles from preforms described in Example 10. Axial stretch ratio is 1.9/1, Hoop Stretch ratio=2.4 & Total Stretch Ratio=4.6/1. This machine is equipped with 3 heater boxes per cavity & uses 1000 Watt IR lamps. Pre-blow pressure was 6 bar & final pressure was 8 bar. After optimization, the bottle productivity for the preforms with 3 mm thickness was 1,030 bph/cav. Bottle quality was judged at the time of production to be Unacceptable (poorly blown bottle or blown out), Acceptable (a fully blown bottle with moderate optical properties), Average (a fully blown bottle with improved optical properties), or Excellent (a fully blown bottle with outstanding optical clarity).

TABLE XI
Example 11 Bottles

| | | | Injection | | |
|---|---|---|---|---|---|
| | | Loading | Speed | % Haze/ | Bottle |
| Example | Nucleator | (ppm) | (g/cc) | thickness | Quality |
| XI-1 | NA-21 | 2000 | 50.6 | 2.048 | Acceptable |
| XI-2 | NA-21 | 2000 | 25.3 | 1.500 | Average |
| XI-3 | NA-21 | 2000 | 16.9 | 0.130 | Excellent |
| XI-4 | NA-21 | 2000 | 12.7 | 0.079 | Excellent |
| XI-5 | NA-21 | 2000 | 10.1 | 0.074 | Excellent |
| XI-6 | NA-21 | 2000 | 8.4 | 0.076 | Excellent |
| XI-7 | NA-21 | 2000 | 7.2 | 0.100 | Excellent |
| XI-8 | NA-21 | 2000 | 6.3 | 0.052 | Excellent |
| XI-9 | NA-11 | 1000 | 50.6 | 2.000 | Acceptable |
| XI-10 | NA-11 | 1000 | 25.3 | 0.739 | Average |
| XI-11 | NA-11 | 1000 | 16.9 | 0.132 | Excellent |
| XI-12 | NA-11 | 1000 | 12.7 | 0.100 | Excellent |
| XI-13 | NA-11 | 1000 | 10.1 | 0.111 | Excellent |
| XI-14 | NA-11 | 1000 | 8.4 | 0.087 | Excellent |
| XI-15 | NA-11 | 1000 | 7.2 | 0.096 | Excellent |
| XI-16 | NA-11 | 1000 | 6.3 | 0.086 | Excellent |
| XI-17 | HPN-68 | 1000 | 50.6 | | Acceptable |
| XI-18 | HPN-68 | 1000 | 25.3 | 1.565 | Average |
| XI-19 | HPN-68 | 1000 | 16.9 | | Excellent |
| XI-20 | HPN-68 | 1000 | 12.7 | | Excellent |
| XI-21 | HPN-68 | 1000 | 10.1 | | Excellent |
| XI-22 | HPN-68 | 1000 | 8.4 | | Excellent |
| XI-23 | HPN-68 | 1000 | 7.2 | | Excellent |
| XI-24 | HPN-68 | 1000 | 6.3 | 0.121 | Excellent |
| XI-25 | AlptBBA | 1000 | 50.6 | | Acceptable |
| XI-26 | AlptBBA | 1000 | 25.3 | 0.304 | Average |
| XI-27 | AlptBBA | 1000 | 16.9 | | Excellent |
| XI-28 | AlptBBA | 1000 | 12.7 | | Excellent |
| XI-29 | AlptBBA | 1000 | 10.1 | | Excellent |
| XI-30 | AlptBBA | 1000 | 8.4 | | Excellent |
| XI-31 | AlptBBA | 1000 | 7.2 | | Excellent |
| XI-32 | AlptBBA | 1000 | 6.3 | 0.186 | Excellent |
| XI-33 | CaHHPA | 1500 | 50.6 | | Acceptable |
| XI-34 | CaHHPA | 1500 | 25.3 | 0.880 | Average |
| XI-35 | CaHHPA | 1500 | 16.9 | | Excellent |
| XI-36 | CaHHPA | 1500 | 12.7 | | Excellent |
| XI-37 | CaHHPA | 1500 | 10.1 | | Excellent |
| XI-38 | CaHHPA | 1500 | 8.4 | | Excellent |
| XI-39 | CaHHPA | 1500 | 7.2 | | Excellent |
| XI-40 | CaHHPA | 1500 | 6.3 | 0.100 | Excellent |
| XI-41 | M3905 | 2000 | 50.6 | | Acceptable |
| XI-42 | M3905 | 2000 | 25.3 | 0.240 | Average |
| XI-43 | M3905 | 2000 | 16.9 | | Average |
| XI-44 | M3905 | 2000 | 12.7 | | Excellent |
| XI-45 | M3905 | 2000 | 10.1 | | Excellent |
| XI-46 | M3905 | 2000 | 8.4 | | Excellent |
| XI-47 | M3905 | 2000 | 7.2 | | Excellent |
| XI-48 | M3905 | 2000 | 6.3 | 0.067 | Excellent |
| XI-49 | M3988 | 2000 | 50.6 | | Acceptable |
| XI-50 | M3988 | 2000 | 25.3 | 1.826 | Average |
| XI-51 | M3988 | 2000 | 16.9 | | Average |
| XI-52 | M3988 | 2000 | 12.7 | | Excellent |
| XI-53 | M3988 | 2000 | 10.1 | | Excellent |
| XI-54 | M3988 | 2000 | 8.4 | | Excellent |
| XI-55 | M3988 | 2000 | 7.2 | | Excellent |
| XI-56 | M3988 | 2000 | 6.3 | 0.058 | Excellent |
| XI-57 | — | — | 50.6 | | Acceptable |
| XI-58 | — | — | 25.3 | 1.917 | Average |
| XI-59 | — | — | 16.9 | | Excellent |
| XI-60 | — | — | 12.7 | | Excellent |
| XI-61 | — | — | 10.1 | | Excellent |
| XI-62 | — | — | 8.4 | | Excellent |
| XI-63 | — | — | 7.2 | | Excellent |
| XI-64 | — | — | 6.3 | 0.083 | Excellent |

### EXAMPLE 12

### 38 mm Neck Bottles Produced Using New ISBM Machine with 3 mm Preforms

Polypropylene bottles (500 ml, table XII) were produced at high speed (1,500 bottles/cavity/hour) on a Sidel SBO-8 Series-II stretch blow molding machine designed to blow PET preforms using the polypropylene preforms described in Example 10. Axial stretch ratio is 2.5/1, Hoop Stretch ratio=2.54 & Total Stretch Ratio=6.36/1. Machine settings were adjusted to accommodate high clarity, high speed bottle production. Preforms were subjected to a pre-blow pressure of 4.5 Bar for 0.4 seconds & nozzle for 3 rotations open activated at ‘point zero’. Blowing time is 0.8 sec & Exhaust time is 0.4 sec. Stretch speed is 1,384 m/sec & a standard stretch rod with 14 mm diameter was used. Preform temperature is about 120-130° C. Heating profile: Z1=75%, Z2=90%, Z3=70%, Z4=70%, Z5=65% & Z6=70% with Z1, Z5 & Z6 in an advanced position. % GP=65%. The invention employed 100% ventilation to cool the preform surface. Total heating time is 14.65 sec, stabilization time=6.0 sec & final stabilization time=4.5 sec. Bottle quality was judged at the time of production to be Unacceptable (poorly blown bottle or blown out), Acceptable (a fully blown bottle with moderate optical properties), Average (a fully blown bottle with improved optical properties), or Excellent (a fully blown bottle with outstanding optical clarity).

TABLE XII
Example 12 Bottles

| | | | Injection | | |
|---|---|---|---|---|---|
| | | Loading | Speed | % Haze/ | Bottle |
| Example | Nucleator | (ppm) | (g/cc) | thickness | Quality |
| XII-1 | NA-21 | 2000 | 50.6 | | Acceptable |
| XII-2 | NA-21 | 2000 | 25.3 | | Average |
| XII-3 | NA-21 | 2000 | 16.9 | | Excellent |
| XII-4 | NA-21 | 2000 | 12.7 | | Excellent |
| XII-5 | NA-21 | 2000 | 10.1 | | Excellent |
| XII-6 | NA-21 | 2000 | 8.4 | | Excellent |
| XII-7 | NA-21 | 2000 | 7.2 | | Excellent |
| XII-8 | NA-21 | 2000 | 6.3 | 0.088 | Excellent |
| XII-9 | NA-11 | 1000 | 50.6 | | Acceptable |
| XII-10 | NA-11 | 1000 | 25.3 | | Average |
| XII-11 | NA-11 | 1000 | 16.9 | | Excellent |
| XII-12 | NA-11 | 1000 | 12.7 | | Excellent |
| XII-13 | NA-11 | 1000 | 10.1 | | Excellent |
| XII-14 | NA-11 | 1000 | 8.4 | | Excellent |
| XII-15 | NA-11 | 1000 | 7.2 | | Excellent |
| XII-16 | NA-11 | 1000 | 6.3 | 0.115 | Excellent |
| XII-17 | HPN-68 | 1000 | 50.6 | | Acceptable |
| XII-18 | HPN-68 | 1000 | 25.3 | | Average |
| XII-19 | HPN-68 | 1000 | 16.9 | | Excellent |
| XII-20 | HPN-68 | 1000 | 12.7 | | Excellent |
| XII-21 | HPN-68 | 1000 | 10.1 | | Excellent |
| XII-22 | HPN-68 | 1000 | 8.4 | | Excellent |
| XII-23 | HPN-68 | 1000 | 7.2 | | Excellent |
| XII-24 | HPN-68 | 1000 | 6.3 | 0.116 | Excellent |
| XII-25 | AlptBBA | 1000 | 50.6 | | Acceptable |
| XII-26 | AlptBBA | 1000 | 25.3 | | Average |
| XII-27 | AlptBBA | 1000 | 16.9 | | Excellent |
| XII-28 | AlptBBA | 1000 | 12.7 | | Excellent |
| XII-29 | AlptBBA | 1000 | 10.1 | | Excellent |
| XII-30 | AlptBBA | 1000 | 8.4 | | Excellent |
| XII-31 | AlptBBA | 1000 | 7.2 | | Excellent |
| XII-32 | AlptBBA | 1000 | 6.3 | 0.164 | Excellent |
| XII-33 | CaHHPA | 1500 | 50.6 | | Acceptable |
| XII-34 | CaHHPA | 1500 | 25.3 | | Average |
| XII-35 | CaHHPA | 1500 | 16.9 | | Excellent |
| XII-36 | CaHHPA | 1500 | 12.7 | | Excellent |
| XII-37 | CaHHPA | 1500 | 10.1 | | Excellent |
| XII-38 | CaHHPA | 1500 | 8.4 | | Excellent |
| XII-39 | CaHHPA | 1500 | 7.2 | | Excellent |
| XII-40 | CaHHPA | 1500 | 6.3 | 0.100 | Excellent |
| XII-41 | M3905 | 2000 | 50.6 | | Acceptable |
| XII-42 | M3905 | 2000 | 25.3 | | Excellent |
| XII-43 | M3905 | 2000 | 16.9 | | Excellent |
| XII-44 | M3905 | 2000 | 12.7 | | Excellent |
| XII-45 | M3905 | 2000 | 10.1 | | Excellent |
| XII-46 | M3905 | 2000 | 8.4 | | Excellent |
| XII-47 | M3905 | 2000 | 7.2 | | Excellent |
| XII-48 | M3905 | 2000 | 6.3 | 0.048 | Excellent |
| XII-49 | M3988 | 2000 | 50.6 | | Acceptable |
| XII-50 | M3988 | 2000 | 25.3 | | Average |
| XII-51 | M3988 | 2000 | 16.9 | | Excellent |
| XII-52 | M3988 | 2000 | 12.7 | | Excellent |
| XII-53 | M3988 | 2000 | 10.1 | | Excellent |
| XII-54 | M3988 | 2000 | 8.4 | | Excellent |
| XII-55 | M3988 | 2000 | 7.2 | | Excellent |
| XII-56 | M3988 | 2000 | 6.3 | 0.076 | Excellent |
| XII-57 | — | — | 50.6 | | Acceptable |
| XII-58 | — | — | 25.3 | | Average |
| XII-59 | — | — | 16.9 | | Excellent |
| XII-60 | — | — | 12.7 | | Excellent |
| XII-61 | — | — | 10.1 | | Excellent |
| XII-62 | — | — | 8.4 | | Excellent |
| XII-63 | — | — | 7.2 | | Excellent |
| XII-64 | — | — | 6.3 | 0.062 | Excellent |

### EXAMPLE 13

### 28 mm Neck, 3 mm Wall Preforms

A commercial homopolymer resin containing Millad 3988 (Mosten MT 230 from Chemopetrol, MFI=30) & random copolymer (Borealis RF365 MO, MFI=20) was used to produce preforms as indicated in Table XIII. The preforms were produced on a two-cavity mold (only one cavity installed) 100 ton Netstal injection molding machine with a variable injection time (0.54.0 sec) and a constant cooling time of 10 sec. Melt temperature was 240° C. Temperature of the cooling water was 13° C. The holding pressure time was 8.4 sec. Total cycle time was around 25 sec (not optimized). A valve gate with a diameter of 1.5 mm was used. The preforms have a wall thickness of 3 mm and a bottle weight of about 20.3 g. These preforms were later blown into bottles as explained in subsequent examples.

TABLE XIII
Example 13 Preforms

| | | | Injection | Injection |
|---|---|---|---|---|
| | | MFI | Time | Speed |
| Example | Resin | (g/10 sec) | (sec) | (g/cc) |
| XIII-1 | HP MT 230 | 30 | 0.5 | 50.6 |
| XIII-2 | HP MT 230 | 30 | 1.0 | 25.3 |
| XIII-3 | HP MT 230 | 30 | 1.5 | 16.9 |
| XIII-4 | HP MT 230 | 30 | 2.0 | 12.7 |
| XIII-5 | HP MT 230 | 30 | 2.5 | 10.1 |
| XIII-6 | HP MT 230 | 30 | 3.0 | 8.4 |
| XIII-7 | HP MT 230 | 30 | 3.5 | 7.2 |
| XIII-8 | HP MT 230 | 30 | 4.0 | 6.3 |
| XIII-9 | RF 365MO | 20 | 2.5 | 50.6 |
| XIII-10 | RF 365MO | 20 | 3.0 | 25.3 |
| XIII-11 | RF 365MO | 20 | 3.5 | 16.9 |
| XIII-12 | RF 365MO | 20 | 4.0 | 12.7 |
| XIII-13 | RF 365MO | 20 | 0.5 | 10.1 |
| XIII-14 | RF 365MO | 20 | 1.0 | 8.4 |
| XIII-15 | RF 365MO | 20 | 1.5 | 7.2 |
| XIII-16 | RF 365MO | 20 | 2.0 | 6.3 |

### EXAMPLE 14

### 28 mm Neck Bottles Produced Using New ISBM Machine with 3 mm Preforms

Polypropylene bottles (500 ml) having a narrow neck were produced at high speed (1500 bottles/cavity/hour) on a Sidel SBO-8 Series-II stretch blow molding machine designed to blow PET preforms using the polypropylene preforms described in Example 13. The following stretch ratios were used: axial stretch ratio of 2.63/1, radial stretch ratio of 3.08 and a total stretch ratio of 8.10/1. Machine settings were adjusted to accommodate high clarity, high speed bottle production. In case of the Chemopetrol MT230 resin (homopolymer with a MFI of about 30 g/10 min) the temperature measured at the outer side of the preform was 143.5° C. and 152.5° C. at the inner side of the preform. In case of the Borealis RF 365 MO (random copolymer with a MFI of 20 g/10 min) the temperature measured at the outer side of the preform was 127.5° C. and 134.8° C. at the inner side of the preform. Bottle quality was judged at the time of production to be Unacceptable (poorly blown bottle or blown out), Acceptable (a fully blown bottle with moderate optical properties), Average (a fully blown bottle with improved optical properties), or Excellent (a fully blown bottle with outstanding optical clarity).

TABLE XIV
Example 14 Bottles

| | MFI | | Injection | | |
|---|---|---|---|---|---|
| | (g/10 | | Speed | % Haze/ | Bottle |
| Example | sec) | Resin | (g/cc) | thickness | Quality |
| XIV-1 | 30 | MT230 (HP) | 50.6 | 2.427 | Acceptable |
| XIV-2 | 30 | MT230 (HP) | 25.3 | | Acceptable |
| XIV-3 | 30 | MT230 (HP) | 16.9 | 0.583 | Acceptable |
| XIV-4 | 30 | MT230 (HP) | 12.7 | 0.373 | Average |
| XIV-5 | 30 | MT230 (HP) | 10.1 | 0.256 | Excellent |
| XIV-6 | 30 | MT230 (HP) | 8.4 | 0.274 | Excellent |
| XIV-7 | 30 | MT230 (HP) | 7.2 | 0.265 | Excellent |
| XIV-8 | 30 | MT230 (HP) | 6.3 | 0.163 | Excellent |
| XIV-9 | 20 | RF 365MO | 50.6 | 50.6 | Acceptable |
| XIV-10 | 20 | RF 365MO | 25.3 | 25.3 | Acceptable |
| XIV-11 | 20 | RF 365MO | 16.9 | 16.9 | Acceptable |
| XIV-12 | 20 | RF 365MO | 12.7 | 12.7 | Acceptable |
| XIV-13 | 20 | RF 365MO | 10.1 | 10.1 | Acceptable |
| XIV-14 | 20 | RF 365MO | 8.4 | 8.4 | Acceptable |
| XIV-15 | 20 | RF 365MO | 7.2 | 7.2 | Average |
| XIV-16 | 20 | RF 365MO | 6.3 | 6.3 | Excellent |

### Thickness

For purposes of this specification, the thickness of preforms is measured along the side walls 101, 104 as shown in FIG. 4A, measured at the widest portion of the side walls 101, 104.

Thickness of containers (bottles), such as for purposes of percent haze/thickness ratios is measured at the point at which the haze has been measured (see below), using a Magna-Mike 8500 Hall effect thickness gauge.

### Haze

For purposes of this specification, haze has been measured on a BYK-Gardner hazemeter by ASTM Standard Test Method D1003-61 modified by use of an 0.2″ aperture. The area in which haze could be measured reliably was in relatively small areas less than about 0.5″ in area. Samples were obtained from sample containers (bottles) at a relatively flat point approximately mid-way to the bottom of the bottle after the transition point. A thickness modified haze was calculated for each sample where (H/t) is defined as the haze divided by the thickness at the point where the haze was measured.

Roughness on the inner container 10 surface has a negative influence on the container clarity. If, during reheating of the preform 115 (within the window of process stability), the temperature in the skin-layer is insufficiently high, the material undesirably may be ruptured apart during the stretch blow molding (stage two) process, resulting in a rough inner container 10 surface and containers 10 having low clarity.

It is understood by one of ordinary skill in the art that the present discussion is a description of exemplary embodiments only, and is not intended as limiting the broader aspects of the present invention, which broader aspects are embodied in the exemplary constructions. The invention is shown by example in the claims.

1. In a two stage process of injection stretch blow molding polypropylene to form a container, wherein a first stage comprises forming a preform article and a second stage comprises reheating and blow molding the preform article to form a container, the first stage comprising the steps of:
(a) providing a chemical composition comprising polypropylene, said chemical composition having a melt flow index in the range of between about 6 and about 50 grams/10 minutes, according to ASTM D 1238;
(b) injecting said chemical composition into a mold at a fill rate of greater than about 5 grams of chemical composition per second;
(c) forming said chemical composition into a preform article, said preform article having a closed end connected to a side wall, said side wall having a maximum thickness of less than about 3.5 mm; and
(d) removing said preform article from said mold.

2. The process of claim 1 further comprising the steps of:
(e) reheating said preform article; and
(f) stretch blow molding said preform article to form a container.

3. The process of claim 1 wherein said side wall thickness of said preform article is between about 1.5 mm and about 3.5 mm.

4. The process of claim 1 wherein said injection step (b) provides said chemical composition into said mold at a fill rate of about 5-22 grams/second.

5. The process of claim 1 wherein said chemical composition comprises an ethylene/propylene copolymer.

6. The process of claim 1 wherein said chemical composition further comprises a nucleating agent.

7. The process of claim 6 wherein said nucleating agent comprises a dibenzylidene sorbitol compound (DBS), or a derivative thereof.

8. The process of claim 6 wherein said nucleating agent comprises sodium 1,3-0-2,4-bis(4-methylbenzylidene) sorbitol and derivatives thereof.

9. The process of claim 6 wherein said nucleating agent comprises sodium benzoate and derivatives thereof.

10. The process of claim 6 wherein said nucleating agent comprises 1,2-cyclohexanedicarboxylate salts and derivatives thereof.

11. The process of claim 6 wherein said nucleating agent comprises aluminum 4-tert-butylbenzonate and derivatives thereof.

12. The process of claim 6 wherein said nucleating agent comprises metal salt(s) of cyclic phosphoric esters and derivatives thereof.

13. The process of claim 6 wherein said nucleating agent comprises bis(3,4-dialkylbenzylidene) sorbitol acetal or derivatives thereof.

14. The process of claim 6 wherein said nucleating agent comprises 1,3-O-2,4-bis(3,4-dimethylbenzylidene) sorbitol or derivatives thereof.

15. The process of claim 6 wherein said nucleating agent comprises disodium bicyclo[2.2.1]heptanedicarboxylate or derivatives thereof.

16. The process of claim 1 wherein said chemical composition comprises a at least one species of polypropylene homopolymer.

17. The process of claim 1 wherein said chemical composition comprises a polypropylene random copolymer.

18. The process of claim 1 wherein said chemical composition comprises a polypropylene block copolymer.

19. The process of claim 2 wherein said injection step (b) employs a gate in operable connection to said cavity mold, further wherein said gate provides a diameter between about 1.5 mm and about 3.8 mm.

20. The process of claim 2 wherein said stretch blow molding step (f) is repeated successively in a manufacturing operation at a rate of container production of greater than about 900 containers per hour per mold.

21. The process of claim 2 wherein said stretch blow molding step (f) is repeated successively in a manufacturing operation at a rate of container production of at least about 1200 containers per hour per mold.

22. The process of claim 2 wherein said blow molding step (f) is repeated successively in a manufacturing operation at a rate of container production of at least about 1500 containers per hour per mold.

23. A preform article formed by employing the process of claim 1.

24. A container formed by employing the process of claim 2.

25. The process of claim 2 wherein said container provides a haze to thickness ratio expressed as a percent haze/mils of less than about 0.05.

26. A process for forming a polypropylene preform article to be used in the manufacture of a container, said process comprising the steps of:
(a) providing a chemical composition comprising in part polypropylene, said chemical composition having a melt flow index in the range between about 13 and about 35 grams/10 minutes, according to ASTM D 1238;
(b) injecting said chemical composition into a mold at a fill rate of greater than about 5 grams of chemical composition per second;
(c) forming said chemical composition into a preform article, said preform article having a closed end and a side wall, said closed end being adapted for subsequent second stage reheating and stretch blow molding, said side wall of said preform article having a thickness of less than about 3.5 mm; and
(d) removing said preform article from said mold.

27. The process of claim 26 wherein said mold further comprises a gate for injecting into said mold said chemical composition, further wherein said gate is provided at a diameter of between about 1.5 mm and 3.8 mm.

28. The process of claim 26, wherein said chemical composition further comprises a nucleating agent.

29. The process of claim 28 wherein said nucleating agent is selected from the group of agents consisting of: dibenzylidene sorbitol-containing compounds, sodium benzoate, cyclohexanedicarboxylate salts, aluminum 4-tert-butylbenzoate, metal salts of phosphoric esters, and derivatives thereof.

30. The process of claim 28 wherein said nucleating agent comprises 1,3-O-2,4-bis(3,4-dimethylbenzylidene) sorbitol (DMDBS) or derivatives thereof.

31. The process of claim 28 wherein said nucleating agent comprises disodium bicyclo[2.2.1]heptanedicarboxylate or derivatives thereof.

32. The process of claim 26 wherein said injection step provides said chemical composition into said mold at a fill rate of about 5-22 grams/second.

33. The process of claim 26 wherein said wall thickness of said preform article is between about 1.5 and about 3.5 mm.

34. The process of claim 27 wherein said gate diameter is about 1.5 mm.

35. The process of claim 26 wherein said fill rate in said step (b) is about 5-11 g/s and said preform side wall thickness is about 2 mm.

36. The process of claim 26 wherein said fill rate in said step (b) is about 5-13 g/s and said preform side wall thickness is about 3 mm.

37. The process of claim 26 wherein said fill rate in said step (b) is about 5-17 g/s and said preform side wall thickness is about 4 mm.

38. The preform article formed by the process of claim 26.

39. The process of claim 26, further comprising the steps of:
(e) reheating said preform article; and
(f) stretch blow molding said preform article to form a container.

40. The container formed by employing the process of claim 39.

41. A process comprising the steps of:
(a) providing a chemical composition comprising polypropylene, said chemical composition having an MFI in the range of between about 13 and about 35 grams/10 minutes, according to ASTM D 1238;
(b) injecting said chemical composition into a mold at a fill rate of greater than about 5 grams of chemical composition per second;
(c) forming said chemical composition into a preform article, said preform article having a sidewall thickness of about 2 mm; and
(d) removing said preform article from said mold.

42. The process of claim 41 wherein further comprising the steps of:
(e) reheating said preform article; and
(f) stretch blow molding said preform article to form a container.

43. A preform article formed using the process of claim 41.

44. A container formed using the process of claim 42.

45. A process comprising the steps of:
(a) providing a chemical composition comprising polypropylene, said chemical composition having an MFI in the range of between about 13 and about 35 grams/10 minutes, according to ASTM D 1238;
(b) injecting said chemical composition into a mold at a fill rate of greater than about 5 grams of chemical composition per second;
(c) forming said chemical composition into a preform article, said preform article having a sidewall thickness of about 3 mm; and
(d) removing said preform article from said mold.

46. The process of claim 45 wherein further comprising the steps of:
(e) reheating said preform article; and
(f) stretch blow molding said preform article to form a container.

47. A preform article formed using the process of claim 45.

48. A container formed using the process of claim 46.

49. A process comprising the steps of:
(a) providing a chemical composition comprising polypropylene, said chemical composition having an MFI in the range of between about 13 and about 35 grams/10 minutes according to ASTM D 1238, said chemical composition further comprising a nucleating agent, said nucleating agent comprising at least in part a p-methyl substituted benzaldehyde sorbitol compound or derivatives thereof;
(b) injecting said chemical composition into a mold at a fill rate of between about 5 and about 22 grams of chemical composition per second;
(c) forming said chemical composition into a preform article, said preform article having a wall thickness of between about 2 mm and about 4 mm; and
(d) removing said preform article from said mold.

50. A preform article formed according to the process of claim 49.

51. A process comprising the steps of:
(a) providing a chemical composition comprising polypropylene, said chemical composition having an MFI in the range of between about 13 and about 35 grams/10 minutes, according to ASTM D 1238, said chemical composition further comprising a nucleating agent, said nucleating agent comprising at least in part disodium bicyclo[2.2.1]heptanedicarboxylate or derivatives thereof;
(b) injecting said chemical composition into a mold at a fill rate of between about 5 and about 22 grams of chemical composition per second;
(c) forming said chemical composition into a preform article, said preform article having a wall thickness of between about 2 mm and about 3.5 mm; and
(d) removing said preform article from said mold.

52. A preform article formed according to the process of claim 51.

53. The process of claim 51 wherein further comprising the steps of:
(e) reheating said preform article; and
(f) stretch blow molding said preform article to form a container.

54. A container formed according to the process of claim 53.

55. A process comprising the steps of:
(a) providing a chemical composition comprising polypropylene, said chemical composition having an MFI in the range of between about 13 and about 35 grams/10 minutes, according to ASTM D 1238;
(b) injecting said chemical composition into a mold at a fill rate of greater than about 5 grams of chemical composition per second;
(c) forming said chemical composition into a preform article, said preform article having an interior wall surface and an exterior wall surface, said preform article further having a side wall thickness between said interior wall surface and said exterior wall surface, said interior wall surface being profiled along its length, said side wall being between about 2 mm and about 4 mm in thickness; and
(d) removing said preform article from said mold.
